(19) United States
(12) Patent Application Publication
(10) Pub. No.: US 2020/0070546 A1
(43) Pub. Date: Mar. 5, 2020

(54) INK JET PRINTING METHOD AND INK JET PRINTING APPARATUS

(71) Applicant: Seiko Epson Corporation, Tokyo (JP)

(72) Inventors: Akira MIZUTANI, Matsumoto (JP); Ippei OKUDA, Shiojiri (JP)

(21) Appl. No.: 16/553,432

(22) Filed: Aug. 28, 2019

(30) Foreign Application Priority Data
Aug. 29, 2018 (JP) 2018-160410

(51) Int. Cl. B41J 11/00

(52) U.S. Cl. CPC B41J 11/0015

(57) ABSTRACT

An ink jet printing method includes a printing step of performing a plurality of times of scanning performed by ejecting a treatment liquid and an ink composition from an ink jet head having treatment liquid nozzles and ink nozzles that is being transferred in a scanning direction, thus applying the treatment liquid and the ink composition onto a printing medium. The ink jet head has an arrangement of treatment liquid ejection nozzles that includes a coincident portion, and an arrangement of ink ejection nozzles that includes a coincident portion, and the coincident portions are coincident in position in the sub-scanning direction with each other. In the printing step, the coincident portion of the arrangement of the treatment liquid ejection nozzles accounts for 60% or more of the length in the sub-scanning direction of the arrangement of the treatment liquid ejection nozzles, and the treatment liquid is applied onto a region of the printing medium in a proportion of from 20% by mass to 50% by mass relative to the ink composition applied onto the region.

The present application is based on, and claims priority from, JP Application Serial Number 2018-160410, filed Aug. 29, 2018, the disclosure of which is hereby incorporated by reference herein in its entirety.

### BACKGROUND

### 1. Technical Field

The present disclosure relates to an ink jet printing method and an ink jet printing apparatus.

### 2. Related Art

There has been known an ink jet printing method for printing images on a printing medium by ejecting very small ink droplets through nozzles of the ejection head of an ink jet printing apparatus. The ink jet printing method has come into use for printing images not only on printing media absorbent of ink, such as plain paper, but also on printing media poorly absorbent of ink (hereinafter referred to as poorly ink-absorbent media), such as art paper and coated paper, and printing media hardly absorbent of ink (hereinafter referred to as ink-non-absorbent media), such as plastic films. In addition, aqueous ink jet ink compositions (hereinafter often referred to as aqueous ink, ink composition, or ink) mainly containing water come into use for printing images on such poorly absorbent or non-absorbent printing media.

In a printing method using aqueous ink jet ink compositions, a treatment liquid capable of flocculating one or more constituents of the ink is used to obtaining high image quality. The treatment liquid is used for printing on poorly absorbent printing media and non-absorbent printing media, as disclosed in, for example, JP-A-2017-203077. Also, there has been known a serial printing method in which an ink jet printing head ejects ink on a printing medium while scanning the printing medium a plurality of times, that is, while relatively moving over the printing medium.

In the serial printing method using an ink composition and a treatment liquid, improved image quality is desired in high-speed printing.

### SUMMARY

[1] According to an aspect of the present disclosure, there is provided an ink jet printing method that performs printing by applying an ink composition and a treatment liquid acting to flocculate one or more constituents of the ink composition onto a poorly absorbent or non-absorbent printing medium. The method includes a printing step of performing, a plurality of times, scanning that is an operation performed by ejecting the treatment liquid and the ink composition from an ink jet head that is being transferred in a scanning direction to apply the treatment liquid and the ink composition onto the printing medium, and a transport step of transporting the printing medium in a sub-scanning direction intersecting the scanning direction. The ink jet head has an arrangement of treatment liquid ejection nozzles that includes a coincident portion, and an arrangement of ink ejection nozzles that includes a coincident portion, and the coincident portion of the arrangement of the treatment liquid ejection nozzles and the coincident portion of the arrangement of the ink ejection nozzles are coincident in position in the sub-scanning direction with each other. In the printing step, the coincident portion of the arrangement of the treatment liquid ejection nozzles accounts for 60% or more of the length in the sub-scanning direction of the arrangement of the treatment liquid ejection nozzles, and the treatment liquid is applied onto a region of the printing medium in a proportion of from 20% by mass to 50% by mass relative to the ink composition applied onto the region.

[2] In the ink jet printing method of [1], the proportion of the treatment liquid applied onto the region of the printing medium relative to the ink composition applied onto the region may be from 20% by mass to 40% by mass.

[3] In the ink jet printing method of [1] or [2], the ink jet head may have an arrangement of treatment liquid nozzles including the arrangement of the treatment liquid ejection nozzles, and an arrangement of ink nozzles including the arrangement of the ink ejection nozzles, and the usage of the ink nozzles represented by the following equation may be 60% or more:

usage (%)=(length in the sub-scanning direction of the arrangement of the ink ejection nozzles)/(length in the sub-scanning direction of the arrangement of the ink nozzles)×100.

[4] In the ink jet printing method of any of [1] to [3], the coincident portion of the arrangement of the treatment liquid ejection nozzles in the printing step may account for 90% or more of the length in the sub-scanning direction of the arrangement of the treatment liquid ejection nozzles.

[5] In the ink jet printing method of any of [1] to [4], the coincident portion of the arrangement of the ink ejection nozzles in the printing step may account for 70% or less of the length in the sub-scanning direction of the arrangement of the ink ejection nozzles.

[6] In the ink jet printing method of any of [1] to [5], the ink composition may contain 1% by mass or less of a polyol organic solvent having a normal boiling point of more than 280° C. relative to the total mass of the ink composition.

[7] In the ink jet printing method of any of [1] to [6], the treatment liquid may contain a flocculant selected from the group consisting of multivalent metal salts, cationic resins, and organic acids.

[8] In the ink jet printing method of any of [1] to [7], the ink jet head may have a nozzle face at which the nozzles are arranged, and the nozzle face at the ink nozzles may have a surface temperature of from 30° C. to 50° C. when the ink composition is applied onto the printing medium in the printing step.

[9] In the ink jet printing method of any of [3] to [8], the arrangement of the ink nozzles in the printing step may be coincident in position with the arrangement of the treatment liquid nozzles in a percentage of 90% or more relative to the length in the sub-scanning direction of the arrangement of the ink nozzles.

[10] According to another aspect of the present disclosure, there is provided an ink jet printing apparatus operable to apply an ink composition and a treatment liquid acting to flocculate one or more constituents of the ink composition onto a printing medium for printing. The ink jet printing apparatus includes an ink jet head having an arrangement of ink nozzles and an arrangement of treatment liquid nozzles, a transfer device configured to transfer the ink jet head in a scanning direction, a transport device configured to transport the printing medium in a sub-scanning direction intersecting the scanning direction, and a control unit configured to control ejection of the ink composition and the treatment liquid from the ink jet head. The control unit also configured to select treatment liquid ejection nozzles from the treatment liquid nozzles and ink ejection nozzles from the ink nozzles for each of a first printing mode and a second printing mode. The treatment liquid ejection nozzles are nozzles through which the treatment liquid is ejected during printing, and the ink ejection nozzles are nozzles through which the ink composition is ejected during printing. A portion of the arrangement of the treatment liquid ejection nozzles and a portion of the arrangement of the ink ejection nozzles are coincident in position in the sub-scanning direction with each other. The coincident portion of the arrangement of the treatment liquid ejection nozzles in the first printing mode accounts for 60% or more of the length in the sub-scanning direction of the arrangement of the treatment liquid ejection nozzles, and the coincident portion of the arrangement of the treatment liquid ejection nozzles in the second printing mode accounts for 50% or less of the length in the sub-scanning direction of the arrangement of the treatment liquid ejection nozzles. Also, the treatment liquid is applied onto a region of the printing medium in a proportion relative to the ink composition applied onto the region of the printing medium, and the proportion of the treatment liquid applied in the first printing mode is higher than the proportion of the treatment liquid applied in the second printing mode.

[11] In the ink jet printing apparatus of [10], the proportion of the treatment liquid applied in the first printing mode may be 1.5 times or more the proportion of the treatment liquid applied in the second printing mode.

[12] In the ink jet printing apparatus of [10] or [11], the coincident portion of the arrangement of the treatment liquid ejection nozzles in the second printing mode may account for 30% or less of the length in the sub-scanning direction of the arrangement of the treatment liquid ejection nozzles.

[13] In the ink jet printing apparatus of any of [10] to [12], in the second printing mode, the proportion of the treatment liquid applied onto a region may be from 5% by mass to 20% by mass relative to the ink composition applied onto the region.

[14] In the ink jet printing apparatus of any of [10] to [13], the proportion of the treatment liquid applied in the first printing mode and the proportion of the treatment liquid applied in the second printing mode may be proportions of the treatment liquid when applied onto the same type of printing medium.

[15] In the ink jet printing apparatus of any of [10] to [14], printing in the first printing mode may be performed on a poorly absorbent or non-absorbent printing medium.

[16] In the ink jet printing apparatus of any of [10] to [15], the coincident portion of the arrangement of the ink ejection nozzles in the second printing mode may account for 50% or less of the length in the sub-scanning direction of the arrangement of the ink ejection nozzles.

[17] In the ink jet printing apparatus of any of [10] to [16], the arrangement of the ink nozzles in the second printing mode has a usage of 60% or more, the usage being represented by the following equation:

usage (%)=(length in the sub-scanning direction of the arrangement of the ink ejection nozzles)/(length in the sub-scanning direction of the arrangement of the ink nozzles)×100.

### BRIEF DESCRIPTION OF THE DRAWINGS

FIG. 1 is a schematic sectional view of an ink jet printing apparatus.

FIG. 2 is a perspective view illustrating a configuration of the carriage and the vicinity thereof of the ink jet printing apparatus shown in FIG. 1.

FIG. 3 is a schematic top view illustrating a nozzle arrangement of an ink jet head.

FIG. 4 is a schematic top view illustrating another nozzle arrangement of an ink jet head.

FIG. 5 is a schematic top view illustrating still another nozzle arrangement of an ink jet head.

FIG. 6 is a schematic top view illustrating an ejection nozzle arrangement of an ink jet head.

FIG. 7 is a schematic top view illustrating another ejection nozzle arrangement of an ink jet head.

FIG. 8 is a schematic top view illustrating still another ejection nozzle arrangement of an ink jet head.

FIG. 9 is a schematic flow chart illustrating an operation of an ink jet printing apparatus.

### DESCRIPTION OF EXEMPLARY EMBODIMENTS

Exemplary embodiments of the present disclosure will now be described. The following embodiments will be described by way of example. The subject matter of the present disclosure can be implemented without being limited to the following embodiments, and various modifications may be made within the scope and spirit of the subject matter of the disclosure.

The ink jet printing method according to an embodiment of the present disclosure performs printing by applying an ink composition and a treatment liquid capable of flocculating one or more constituents of the ink composition onto a poorly absorbent or non-absorbent printing medium. The method includes a printing step of performing scanning a plurality of times that is an operation performed by ejecting the treatment liquid and the ink composition from an ink jet head that is being transferred in a scanning direction to apply the treatment liquid and the ink composition onto the printing medium, and a transport step of transporting the printing medium in a sub-scanning direction intersecting the scanning direction. The ink jet head has an arrangement of treatment liquid ejection nozzles that includes a coincident portion, and an arrangement of ink ejection nozzles that includes a coincident portion, and the coincident portion of the arrangement of the treatment liquid ejection nozzles and the coincident portion of the arrangement of the ink ejection nozzles are coincident in position in the sub-scanning direction with each other. In the printing step, the coincident portion of the arrangement of the treatment liquid ejection nozzles accounts for 60% or more of the length in the sub-scanning direction of the arrangement of the treatment liquid ejection nozzles, and the treatment liquid is applied onto a region of the printing medium in a proportion of from 20% by mass to 50% by mass relative to the ink composition applied onto the region.

The ink jet printing apparatus according to an embodiment of the present disclosure is operable to apply an ink composition and a treatment liquid capable of flocculating one or more constituents of the ink composition onto a printing medium for printing. The ink jet printing apparatus includes an ink jet head having an arrangement of ink nozzles and an arrangement of treatment liquid nozzles, a transfer device configured to transfer the ink jet head in a scanning direction, a transport device configured to transport the printing medium in a sub-scanning direction intersecting the scanning direction, and a control unit configured to control ejection of the ink composition and the treatment liquid from the ink jet head. The control unit also configured to select treatment liquid ejection nozzles from the treatment liquid nozzles and ink ejection nozzles from the ink nozzles for each of a first printing mode and a second printing mode. The treatment liquid ejection nozzles are nozzles through which the treatment liquid is ejected during printing, and the ink ejection nozzles are nozzles through which the ink composition is ejected during printing. The arrangement of the treatment liquid ejection nozzles includes a coincident portion, the arrangement of the ink ejection nozzles include a coincident portion, and the coincident portion of the arrangement of the treatment liquid ejection nozzles and the coincident portion of the arrangement of the ink ejection nozzles are coincident in position in the sub-scanning direction with each other. The coincident portion of the arrangement of the treatment liquid ejection nozzles in the first printing mode accounts for 60% or more of the length in the sub-scanning direction of the arrangement of the treatment liquid ejection nozzles, and the coincident portion of the arrangement of the treatment liquid ejection nozzles in the second printing mode accounts for 50% or less of the length in the sub-scanning direction of the arrangement of the treatment liquid ejection nozzles. The treatment liquid is applied onto a region of the printing medium in a proportion relative to the ink composition applied onto the region of the printing medium, and the proportion of the treatment liquid applied in the first printing mode is higher than the proportion of the treatment liquid applied in the second printing mode.

Some embodiments of the ink jet printing method and the ink jet printing apparatus according to the present disclosure will be described in the following order: the ink jet printing apparatus, an ink jet head, the ink composition, the treatment liquid, the printing medium, and the ink jet printing method.

### 1. Components

### 1. 1. Ink Jet Printing Apparatus

An ink jet printing apparatus used in the ink jet printing method according to an embodiment of the present disclosure will now be described with reference to the drawings.

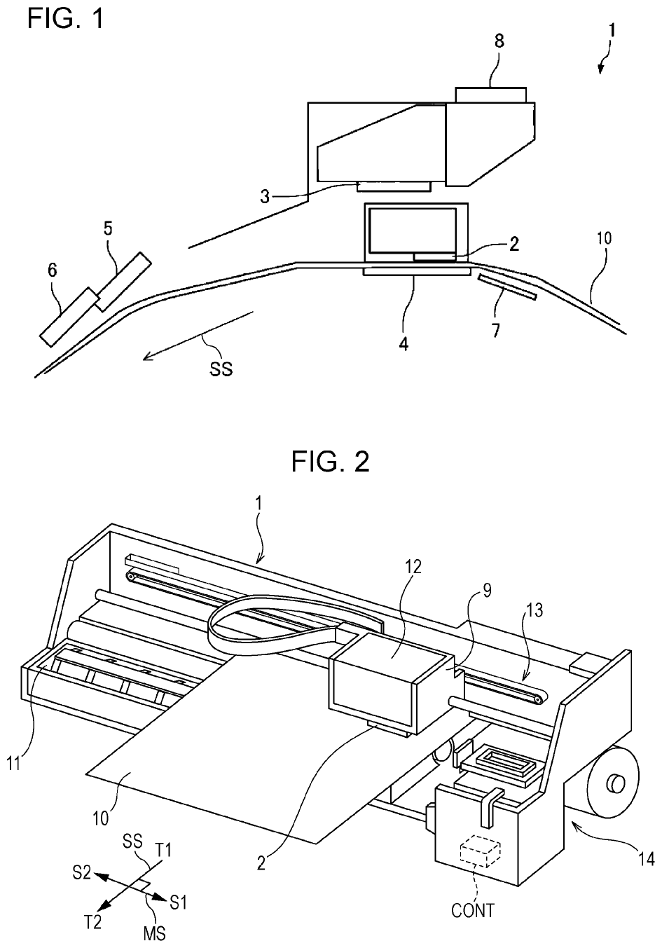

FIG. 1 is a schematic sectional view of an ink jet printing apparatus. FIG. 2 is a perspective view illustrating a configuration of the carriage and the vicinity thereof of the ink jet printing apparatus 1 shown in FIG. 1. As shown in FIGS. 1 and 2, the ink jet printing apparatus 1 includes an ink jet head 2, an IR heater 3, a platen heater 4, a secondary heater 5, a cooling fan 6, a preheater 7, a ventilation fan 8, a carriage 9, a platen 11, a carriage transfer mechanism 13, a transport device 14, and a control unit CONT. The general operation of the ink jet printing apparatus 1 is controlled by the control unit CONT shown in FIG. 2.

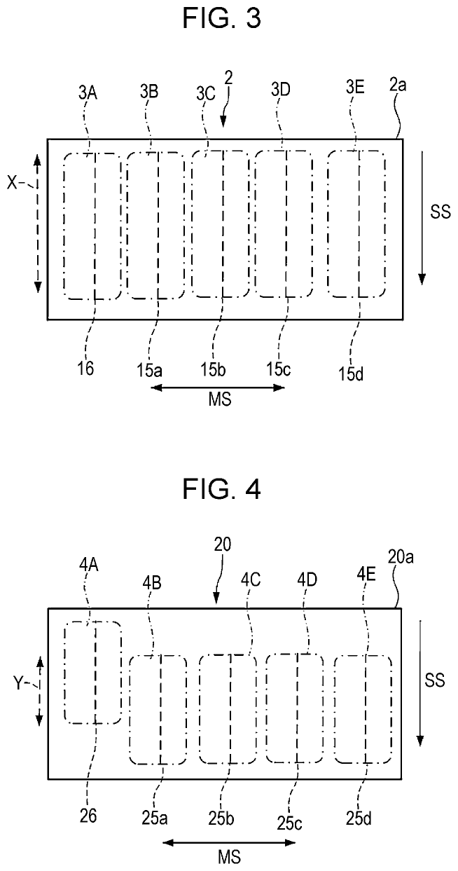

The ink jet head 2 is a device configured to eject an ink composition and a treatment liquid capable of flocculating one or more constituents of the ink composition through nozzles (see FIG. 3), thus applying the ink composition and the treatment liquid onto a printing medium 10. In the present disclosure, the ink jet head 2 is of a serial printing type that applies the ink composition and the treatment liquid onto the printing medium 10 while scanning the printing medium 10 in a scanning direction a plurality of times. The ink jet head 2 is mounted in the carriage 9 shown in FIG. 2. The ink jet head 2 scans the printing medium 10 in the scanning direction a plurality of times along with the operation of the carriage transfer mechanism 13 that transfers the carriage 9 in the width direction of the printing medium 10. The width direction of the printing medium is the scanning direction in which the ink jet head 2 scans the printing medium 10. A path or movement of the ink jet head 2 in the scanning direction is referred to as a scan.

Ejection of liquid from the ink jet head 2 may be performed by a known technique. For example, the ink jet head 2 may eject droplets by vibration of piezoelectric elements, that is, eject droplets formed by mechanical deformation of electrostrictive elements. The configuration of the ink jet head 2 and the carriage 9 and the vicinity thereof will be described in detail later herein.

The ink jet printing apparatus 1 includes the IR heater 3 and the platen heater 4 that are operable to heat the printing medium 10 when the ink composition and the treatment liquid are ejected from the ink jet head 2, that is, operable for primary heating or primary drying. In the present disclosure, when the printing medium 10 is heated in the ink application step described later herein, at least one of the IR heater 3 and the platen heater 4 is used.

When the IR heater 3 is used, the printing medium 10 is heated from the side on which the ink jet head 2 is located. In this instance, the ink jet head 2 is likely to be heated simultaneously with the printing medium 10. However, the printing medium can be efficiently heated without interference of the thickness thereof, unlike when the platen heater 4 or the like heats the printing medium 10 from the rear side. When the platen heater 4 is used for heating the printing medium 10, the printing medium 10 is heated from the opposite side to the ink jet head 2. In this instance, the ink jet head 2 is less likely to be heated.

The upper limit of the surface temperature of the printing medium 10 heated by the IR heater 3 and/or the platen heater 4 may be 45° C. or less, for example, 40° C. or less, 38° C. or less, or 35° C. or less. Also, the lower limit of the surface temperature of the printing medium 10 may be 25° C. or more, for example, 28° C. or more, 30° C. or more, or 32° C. or more. In this instance, the ink composition in the ink jet head 2 is little or not affected by the radiant heat from the IR heater 3 and the platen heater 4. Thus, the ink composition is unlikely to be dried or deteriorated, and the constituents of the ink composition are unlikely to melt and adhere to the inner wall of the ink jet head 2. Also, the ink is rapidly solidified to increase image quality.

The secondary heater 5 is operable to dry or solidify the ink composition applied onto the printing medium 10, that is, acts as an auxiliary heater or dryer. The secondary heater 5 heats the image printed on the printing medium 10 to rapidly evaporate the water or any other solvent from the ink in the image, so that the resin remaining in the ink forms an ink coating film. Thus, the ink coating film is firmly fixed or adheres to the printing medium 10, thus forming a high-quality image in a short time. The upper limit of the surface temperature of the printing medium 10 heated by the secondary heater 5 may be 120° C. or less, for example, 100° C. or less or 90° C. or less. Also, the lower limit of the surface temperature of the printing medium 10 at this time may be 60° C. or more, for example, 70° C. or more or 80° C. or more. By controlling the surface temperature of the printing medium in such a range, high-quality images can be formed in a short time.

The ink jet printing apparatus 1 may include a cooling fan 6. By cooling the ink composition applied onto the printing medium 10 with the cooling fan 6 after drying, the ink composition can form an ink coating film on the printing medium 10 with a high adhesion.

The ink jet printing apparatus 1 may also include a preheater 7 operable to previously heat the printing medium 10 before the ink composition is applied onto the printing medium 10. Furthermore, the ink jet printing apparatus 1 may include a ventilation fan 8 operable to efficiently dry the ink composition or the treatment liquid applied onto the printing medium 10.

Below the carriage 9 are disposed a platen 11 over which the printing medium 10 is transported, a carriage transfer mechanism 13 operable to transfer the carriage 9 relative to the printing medium 10, and a transport device 14 that is a roller operable to transport the printing medium 10 in the sub-scanning direction. The carriage transfer mechanism 13 is configured to move the ink jet head 2 so as to sweep across (scan) the printing medium in the scanning direction. A control unit CONT controls the operations of the carriage transfer mechanism 13 and the transport device 14.

The ink jet printing apparatus 1 operates in a first printing mode and a second printing mode, as will be described later herein. The first and the second printing mode are different in amount (proportion) of the treatment liquid to be applied onto a region of the printing medium 10 relative to the ink composition to be applied onto the region of the printing medium 10. The amounts of the treatment liquid and the ink composition to be applied in each printing mode are controlled by the control unit CONT. The first printing mode is intended for printing on poorly absorbent or non-absorbent printing media. In this mode, the treatment liquid is applied in a higher proportion than in the second printing mode relative to the amount of the ink composition applied. The second printing mode covers printing on any type of printing media.

### 1. 2. Ink Jet Head

In the present disclosure, the ink jet head 2 is operable to eject the ink composition and the treatment liquid to apply them onto the printing medium 10 while being transferred in the scanning direction by the movement of the carriage 9. The ink jet head 2 thus scans the printing medium 10 for printing in a scanning direction a plurality of times.

In the embodiment disclosed herein, the scanning direction is a direction in which the carriage 9 equipped with the ink jet head 2 moves. In FIG. 1, the scanning direction intersects the sub-scanning direction indicated by arrow SS that is the direction in which the printing medium 10 is transported. In FIG. 2, the width direction of the printing medium 10, that is, the S1-S2 directions are the scanning direction MS, and the T1→T2 direction is the sub-scanning direction SS. When the ink jet head 2 scans the printing medium once, the ink jet head 2 moves in a scanning direction, that is, toward either the right side or the left side of the ink jet printing apparatus 1. By alternately repeating such scanning operation by the ink jet head 2 and sub-scanning operation for transporting the printing medium 10, images are printed on the printing medium 10.

In the embodiment disclosed herein, the cartridge 12 operable to feed the ink composition and the treatment liquid to the ink jet head 2 includes a plurality of cartridges independent from each other. The cartridge 12 is removably mounted on the cartridge 9 equipped with the ink jet head 2. Each of the cartridges contains a different type of ink composition or the treatment liquid, and the ink compositions and the treatment liquid are fed to the nozzles from the respective cartridges 12. Although the embodiment disclosed herein illustrates the cartridge 12 mounted on the carriage 9, a cartridge of an embodiment may be disposed at a position other than the carriage 9 so that the inks and the treatment liquid can be fed to the nozzles through a feed tube (not shown).

FIG. 3 illustrates an example of the nozzle arrangement at a surface (hereinafter referred to as a nozzle face) 2a of the ink jet head 2. The ink jet head 2 has a nozzle face 2a having a plurality of nozzles through which ink compositions and a treatment liquid are ejected. In the embodiment shown in FIG. 3, the nozzle face 2a of an ink jet head 2 has ink nozzles grouped into 15a to 15d and treatment liquid nozzles 16. The ink nozzles in each group are filled with an ink and arranged in the sub-scanning direction. The treatment liquid nozzles are filled with the treatment liquid and arranged in the sub-scanning direction. The treatment liquid nozzles 16 may be arranged in a single line or a plurality of lines. In the embodiment shown in FIG. 3, the treatment liquid nozzles 16 are arranged in a single line. In FIG. 3, MS represents the scanning direction.

In the embodiment shown in FIG. 3, the line (arrangement) of the treatment liquid nozzles 16 includes a coincident portion, and the lines (arrangements) of the ink nozzles 15a to 15d each include a coincident portion. The coincident portions are coincident in position in the sub-scanning direction with each other The coincident portion of each group or line (arrangement) in this instance refers to the portion within the range represented by X in FIG. 3. X also represents the length in the sub-scanning direction of the region in which the region 3A including the treatment liquid nozzles 16 is coincident with the regions 3B to 3E including the ink nozzles 15a to 15d, respectively. In the embodiment shown in FIG. 3, the coincident portions have a length in the sub-scanning direction that accounts for 100% of the length in the sub-scanning direction of the arrangement of the treatment liquid nozzles 16 and is also accounts for 100% of the length in the sub-scanning direction of the arrangements of the ink nozzles 15a to 15d. When the coincident portions in the region X account for 100%, the treatment liquid and the ink can be simultaneously ejected in one scan, and accordingly, printing speed is increased. In addition, in this nozzle arrangement, since the lines of the nozzles are arranged side by side, the printing apparatus including the ink jet head 2 and the carriage 9 can be downsized.

FIG. 4 schematically illustrates another nozzle arrangement. In the embodiment shown in FIG. 4, the nozzle face 20a of the ink jet head 20 has ink nozzles grouped into 25a to 25d and treatment liquid nozzles 26. The ink nozzles in each group are filled with an ink and arranged in the sub-scanning direction. The treatment liquid nozzles 26 are filled with the treatment liquid and arranged in the sub-scanning direction. The arrangement of the treatment liquid nozzles 26 includes a coincident portion and the arrangements of the ink nozzles 25a to 25d each include a coincident portion. The coincident portions are coincident in position in the sub-scanning direction with each other. The coincident portion of each line (arrangement) in this instance refers to the portion within the range represented by Y in FIG. 4. Y also represents the length in the sub-scanning direction of the region in which the region 4A including the treatment liquid nozzles 26 is coincident with the regions 4B to 4E including the ink nozzles 25a to 25d, respectively. In the embodiment shown in FIG. 4, the coincident portions with a length Y account for about ⅔ of the length in the sub-scanning direction of the arrangement of the treatment liquid nozzles 26 and also accounts for about ⅔ of the length in the sub-scanning direction of the arrangements of the ink nozzles 25a to 25d. When the coincident portion with a length Y accounts for a part of the length of the arrangements of the nozzles shown in FIG. 4, part of the treatment liquid and inks can be simultaneously applied in one scan. In this instance, the length of each nozzle group extending in the sub-scanning direction is reduced to smaller than that in the embodiment shown in FIG. 3, and accordingly, the printing speed is reduced to lower than that in the case shown in FIG. 3. However, in the embodiment shown in FIG. 4, since the ink is applied after the treatment liquid applied onto the printing medium 10 has been dried to some extent, the ink and the treatment liquid react with each other on the printing medium 10 sufficient to increase image quality. Beneficially, the length Y of the coincident portion accounts for ⅔ or more of the arrangement of the treatment liquid nozzles. Also, beneficially, the length Y of the coincident portion accounts for ⅔ or more of the arrangement of the ink nozzles. Such an arrangement can reduce the mass of the head relative to the mass of a head having a specific arrangement and is therefore beneficial.

In the embodiment shown in FIG. 4, the treatment liquid nozzles 26 are located more upstream than the ink nozzles 25a to 25d. When the length of each nozzle group extending in the sub-scanning direction is increased to the same length as in FIG. 3 in this nozzle arrangement, the size of the apparatus including the ink jet head 2, the carriage 9, or the like is likely to be increased in the sub-scanning direction, compared to the case shown in FIG. 3. Accordingly, it is beneficial, in the arrangement shown in FIG. 4, to arrange the nozzles so that the length Y of the coincident portion accounts for 80% or more of the length in the sub-scanning direction of the arrangements of the ink nozzles 25a to 25d. In some embodiments, the length Y may account for 85% or more or 90% or more. Similarly, it is beneficial to arrange the nozzles so that the length Y of the coincident portion accounts for 80% or more, more beneficially 85% or more or 90% or more, of the length in the sub-scanning direction of the arrangement of the treatment liquid nozzles 26. Also, it is beneficial to arrange the nozzles so that the length Y of the coincident portion accounts for 80% or more, more beneficially 85% or more or 90% or more, of the length in the sub-scanning direction of the arrangement of the ink nozzles.

FIG. 6 illustrates an arrangement as shown in FIG. 3. In this arrangement, however, the treatment liquid nozzles located upstream in the sub-scanning direction from the arrangement of the treatment liquid nozzles 16 are defined as treatment liquid ejection nozzles, and the ink nozzles located downstream in the sub-scanning direction from the arrangements of the ink nozzles 15a to 15d are defined as ink ejection nozzles.

The treatment liquid nozzles 16 in the hatched region located downstream in the sub-scanning direction are not used for printing, while the treatment liquid nozzles in the unhatched region located upstream in the sub-scanning direction are treatment liquid ejection nozzles used for printing. The ink nozzles 15a to 15d in the hatched regions located upstream in the sub-scanning direction are not used for printing, while the ink nozzles in the unhatched regions located downstream in the sub-scanning direction are ink ejection nozzles used for printing.

The treatment liquid ejection nozzles and the ink ejection nozzles are effective nozzles used for printing and are located in a region from the most upstream to the most downstream in the sub-scanning direction of the treatment liquid nozzles.

Thus, the arrangement shown in FIG. 3 may be modified so that only some of the treatment liquid nozzles 16, located upstream in the sub-scanning direction are used to eject the treatment liquid therethrough for printing. These nozzles of the treatment liquid nozzles used to eject the treatment liquid therethrough are referred to as treatment liquid ejection nozzles. Also, the nozzle arrangement may be modified so that only some of the ink nozzles 15a to 15d, located downstream in the sub-scanning direction are used to eject ink therethrough for printing. These nozzles of the ink nozzles used to eject ink therethrough for printing are referred to as ink ejection nozzles.

In this instance, the arrangement of the treatment liquid nozzles 16 and the arrangements of the ink nozzles 15a to 15d are 100% coincident with each other, while the arrangement of the treatment liquid ejection nozzles and the arrangements of the ink ejection nozzles are 0% coincident with each other. In this instance, only the treatment liquid is first applied onto the printing medium in one scan, and ink is then applied onto the same position in the following scan. Since the ink is applied in a state where the entire amount of the treatment liquid to be applied has been applied, the ink reliably comes into contact with the treatment liquid to ensure a reaction with treatment liquid, thus increasing image quality. However, only half of the nozzles of the ink jet head 2 are used, and printing speed is reduced accordingly. The arrangement shown in FIG. 6 is the same as the arrangement shown in FIG. 3 except for the point just described.

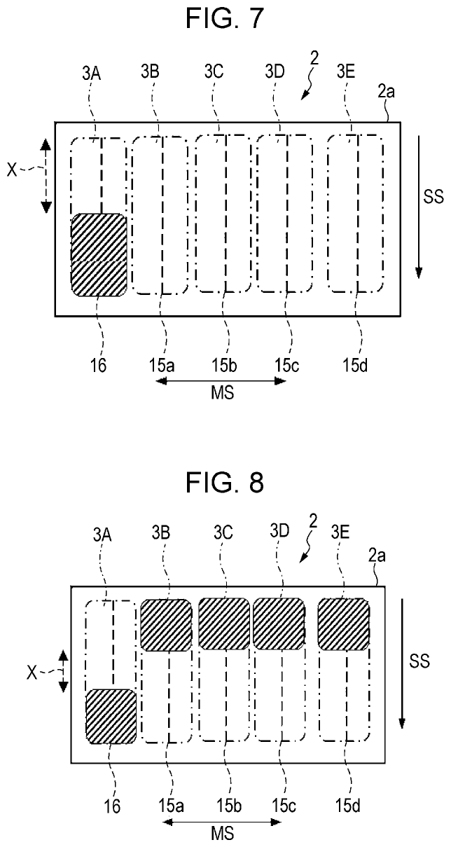

FIG. 7 also illustrates an arrangement as shown in FIG. 3. In this arrangement, however, some of the treatment liquid nozzles 16 located upstream in the sub-scanning direction are defined as treatment liquid ejection nozzles, and all the ink nozzles 15a to 15d are defined as ink ejection nozzles. The treatment liquid nozzles 16 in the hatched region located downstream in the sub-scanning direction are not used for printing, while the treatment liquid nozzles in the unhatched region located upstream in the sub-scanning direction are treatment liquid ejection nozzles used for printing. The treatment liquid ejection nozzles and the ink ejection nozzles are coincident with each other in a region indicated by X.

Thus, the arrangement shown in FIG. 3 may be modified so that only some of the treatment liquid nozzles 16 located upstream in the sub-scanning direction are used to eject the treatment liquid therethrough for printing and so that all the ink nozzles 15a to 15d are used to eject ink therethrough for printing. In this instance, the arrangement of the treatment liquid nozzles 16 is 100% coincident with the arrangements of the ink nozzles 15a to 15d, while the coincident portions of the arrangement of the treatment liquid ejection nozzles and the arrangements of the ink ejection nozzles, coincident with each other are 50% of the arrangement of the ink ejection nozzles and is 100% of the arrangement of the treatment liquid ejection nozzles. In this instance, the printing speed is the same as in the above-described arrangement in which all the treatment liquid nozzles 16 are filled with the treatment liquid. However, the resulting image quality is likely to be superior to the image quality obtained in the arrangement in which all the treatment liquid nozzles 16 are filled with the treatment liquid but is likely to be inferior to the image quality obtained in the arrangement shown in FIG. 4. The arrangement shown in FIG. 7 is the same as the arrangement shown in FIG. 3 except for the point just described.

FIG. 8 illustrates an arrangement as shown in FIG. 3. In this arrangement, however, the treatment liquid nozzles in the upstream two-thirds in the sub-scanning direction of the arrangement of the treatment liquid nozzles 16 are defined as treatment liquid ejection nozzles, and the ink nozzles in the downstream two-thirds in the sub-scanning direction of the arrangements of the ink nozzles 15a to 15d are defined as ink ejection nozzles. The treatment liquid nozzles 16 in the hatched region located downstream in the sub-scanning direction are not used for printing, while the treatment liquid nozzles in the unhatched region located upstream in the sub-scanning direction are treatment liquid ejection nozzles used for printing. The ink nozzles of the ink nozzles 15a to 15d in the hatched regions located upstream in the sub-scanning direction are not used for printing, while the ink nozzles in the unhatched regions located downstream in the sub-scanning direction are ink ejection nozzles used for printing. The treatment liquid ejection nozzles and the ink ejection nozzles are coincident with each other in a region indicated by X. In this instance, the arrangement of the treatment liquid nozzles 16 is 100% coincident with the arrangements of the ink nozzles 15a to 15d, while the coincident portions of the arrangement of the treatment liquid ejection nozzles with the arrangement of the ink ejection nozzles are 50% of the arrangement of the ink ejection nozzles and are also 50% of the arrangement of the treatment liquid ejection nozzles. The arrangement shown in FIG. 8 is the same as the arrangement shown in FIG. 3 except for the point just described.

The ratio of the length in the sub-scanning direction of the coincident portion of the arrangement of the treatment liquid ejection nozzles, coincident with the arrangement of the ink ejection nozzles to the length in the sub-scanning direction of the arrangement of the treatment liquid ejection nozzles is referred to as the coincidence ratio of the treatment liquid ejection nozzles. Similarly, the ratio of the length in the sub-scanning direction of the coincident portion of the arrangement of the ink ejection nozzles, coincident with the arrangement of the treatment liquid ejection nozzles to the length in the sub-scanning direction of the arrangements of the ink ejection nozzles is referred to as the coincidence ratio of the ink ejection nozzles.

In the embodiment shown in FIG. 3, the all the treatment liquid nozzles are used as treatment liquid ejection nozzles for printing, and all the ink nozzles are used as ink ejection nozzles for printing. Hence, the treatment liquid nozzles and the ink nozzles are used 100%. Also, the coincidence ratio of the treatment liquid ejection nozzles and the coincidence ratio of the ink ejection nozzles are each 100%. The coincidence ratios of the treatment liquid ejection nozzles and the ink ejection nozzles may be set independently, for example, from 0% to 100% without being limited to those in the cases shown in FIGS. 3 and 6 to 8. For adjusting the coincidence ratio, the usage (percentage) of the treatment liquid nozzles and/or ink nozzles may be varied. For setting the usage to less than 100%, the treatment liquid ejection nozzles may be selected in the order of the sub-scanning direction from the most upstream nozzle, and the ink ejection nozzles may be selected in the order opposite to the sub-scanning direction. In other words, when the arrangement of the treatment liquid ejection nozzles includes a portion not coincident with the arrangement of the ink ejection nozzles, the portion that is not coincident may be located upstream in the sub-scanning direction from the coincident treatment liquid ejection nozzles. In other words, when the arrangement of the ink ejection nozzles includes a portion not coincident with the arrangement of the treatment liquid ejection nozzles, the portion that is not coincident may be located downstream in the sub-scanning direction from the coincident ink ejection nozzles. Such a nozzle arrangement is beneficial for obtaining high image quality. The usage in percentage of the nozzles will be described later herein.

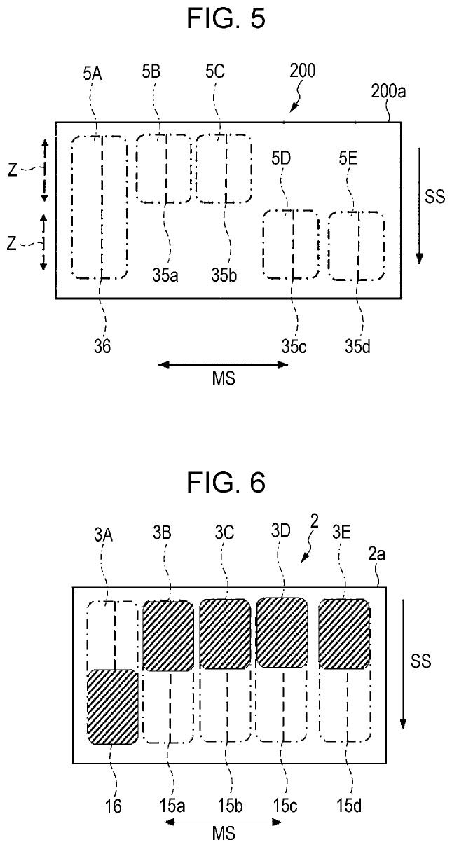

In the arrangements shown in FIGS. 4 and 5, the coincidence ratios of the ejection nozzles may be controlled by selecting treatment liquid ejection nozzles and ink ejection nozzles as desired, as in the case of FIG. 3.

FIG. 5 schematically illustrates still another arrangement of the nozzles. In the arrangement shown in FIG. 5, the nozzle face 200a of an ink jet head 200 has treatment liquid nozzles 36 and ink nozzles grouped into 35a to 35d. The groups 35a to 35d of the ink nozzles each have a coincident portion that is coincident in position in the sub-scanning direction with the arrangement of the treatment liquid nozzles 36. The coincident portion mentioned here refers to the portion within either range represented by Z in FIG. 5. Z also represents the length in the sub-scanning direction of the region in which the region 5A including the treatment liquid nozzles 36 is coincident with any of the regions 5B to 5E including the ink nozzles 35a to 35d, respectively. In this arrangement, the ink nozzles 35a and 35b are arranged upstream in the sub-scanning direction, and the ink nozzles 35c and 35d are arranged downstream in the sub-scanning direction. In such an arrangement, the ink nozzles 35a and 35b are not coincident in position in the sub-scanning direction with the ink nozzles 35c and 35d.

In the arrangement shown in FIG. 5, the ink ejected through the ink nozzles in the arrangements not coincident with each other in the sub-scanning direction are not applied onto the same region on the printing medium in a scan. For example, the ink in the ink nozzles 35a may be applied onto a region in a scan, and the ink in the ink nozzles 35c may be applied onto the region in another scan. In this instance, the inks in the ink nozzles 35a and the ink nozzles 35c are applied onto different regions of a printing medium, and after a period of time for one scan has passed, those regions receive the other of the inks. Thus, inks are not likely to cause color mixing on the printing medium. For example, the ink nozzles 35a may be filled with a white ink, and the ink nozzles 35c may be filled with a non-white ink.

In the arrangement shown in FIG. 5, the ink nozzles 35a and 35b are arranged upstream in the sub-scanning direction, and the ink nozzles 35c and 35d are arranged downstream in the sub-scanning direction so as not to be coincident in the sub-scanning direction with the ink nozzles 35a and 35b. In such an arrangement, any group of the ink nozzles may be arranged upstream independent of other groups or may be arranged downstream. Also, the number of groups or lines of the ink nozzles arranged upstream and the number of groups of the ink nozzles arranged downstream are not limited to those disclosed herein.

In another arrangement in which the treatment liquid nozzles are located more upstream than the ink nozzles in the sub-scanning direction, as shown in FIG. 4, the ink nozzles may be arranged in such a manner that some of the ink nozzles are located more upstream than the other in the sub-scanning direction, as shown in FIG. 5. In this instance as well, it is beneficial to arrange the nozzles in such a manner that each group of the ink nozzles 35a to 35d is at least partially coincident in position in the sub-scanning direction with the treatment liquid nozzles 36. Such an arrangement has both features of the arrangement shown in FIG. 4 and the arrangement shown in FIG. 5.

In the embodiments shown in FIGS. 3 to 5, the treatment liquid nozzles and the ink nozzles are arranged at the nozzle face of the ink jet head as described above. From the viewpoint of high-speed printing, all the nozzles may be used for printing. Alternatively, some of the treatment liquid nozzles and some of the ink nozzles arranged at the nozzle face of the ink jet head may be selected for use for printing from the viewpoint of increasing image quality. In this instance, the selected nozzles may be arranged as in any of the arrangements shown in FIGS. 3 to 5. When some of the nozzles are selected, the nozzles selected as treatment liquid ejection nozzles and ink ejection nozzles used for printing are arranged like the treatment liquid nozzles and the ink nozzles shown in FIGS. 3 to 5.

In any of the embodiments of the present disclosure, printing in a first printing mode is performed in an arrangement in which the coincidence ratio, which the ratio of the length in the sub-scanning direction of the coincident portion of the arrangement of the treatment liquid ejection nozzles coincident in position with the arrangement of the ink ejection nozzles to the length in the sub-scanning direction of the arrangement of the treatment liquid ejection nozzles, is 60% or more, beneficially, 70% or more, 80% or more, or 90% or more. In some embodiments, in the first printing mode, the coincidence ratio may be 100%. The nozzle arrangement with such a coincidence ratio of the treatment liquid ejection nozzles enables high image quality to be produced on poorly absorbent or non-absorbent printing media by a high-speed serial ink jet printing method using an ink composition and a treatment liquid.

In some embodiments of the present disclosure, printing in the first printing mode is performed in an arrangement in which the coincidence ratio of the ink ejection nozzles, which is the ratio of the length in the sub-scanning direction of the coincident portion of the arrangements of the ink ejection nozzles coincident in position with the arrangement of the treatment liquid ejection nozzles to the length in the sub-scanning direction of the arrangements of the ink ejection nozzles, may be 60% or more, 63% or more, or 65% or more. Beneficially, the coincidence ratio of the ink ejection nozzles may be 95% or more. In addition, from the viewpoint of further increasing image quality, the coincidence ratio of the ink ejection nozzles may be 80% or less, 75% or more, or 70% or less. The nozzle arrangement with such a coincidence ratio of the ink ejection nozzles enables high image quality to be produced on poorly absorbent or non-absorbent printing media by a high-speed serial ink jet printing method using an ink composition and a treatment liquid.

In the second printing mode, printing is performed in an arrangement in which the coincidence ratio of the treatment liquid ejection nozzles, which is the ratio of the length in the sub-scanning direction of the coincident portion of the arrangement of the treatment liquid ejection nozzles to the length in the sub-scanning direction of the arrangement of the treatment liquid ejection nozzles, is 50% or less, beneficially, 45% or less, 40% or less, or 30% or less. In some embodiments, the coincidence ratio of the treatment liquid ejection nozzles in the second printing mode maybe 20% or less. By setting the coincidence ratio as above, image quality can be increased in a printing mode different from the first printing mode.

In the second printing mode, the coincidence ratio of the ink ejection nozzles, which is the ratio of the length in the sub-scanning direction of the coincident portion of the arrangement of the ink ejection nozzles to the length in the sub-scanning direction of the arrangements of the ink ejection nozzles, is 50% or less, beneficially, 45% or less, 40% or less, or 30% or less. In some embodiments, the coincidence ratio of the ink ejection nozzles in the second printing mode may be 20% or less.

The nozzle arrangement with a coincidence ratio of 100% is an arrangement as shown in FIG. 3 in which all the treatment liquid nozzles 16 and the ink nozzles 15a to 15d are used for printing.

An arrangement with a coincidence ratio of 60% is an arrangement in which the length of the coincident portion of the treatment liquid ejection nozzles (effective nozzles to be used for printing of the treatment liquid nozzles 16) coincident in position in the sub-scanning direction with the ink ejection nozzles (effective nozzles to be used for printing of the ink nozzles 15a to 15d) accounts for 60% of the length in the sub-scanning direction of the arrangement of the treatment liquid ejection nozzles. For arranging the nozzles in such a manner, the usage (percentage) of the treatment liquid nozzles and/or ink nozzles may be controlled.

The usage of the ink nozzles is represented by the following equation (1):

Usage (%)=(length in the sub-scanning direction of the arrangement of the ink ejection nozzles/length in the sub-scanning direction of the arrangement of the ink nozzles)×100 (1)

The usage of the treatment liquid nozzles is represented by the following equation (2):

Usage (%)=(length in the sub-scanning direction of the arrangement of the treatment liquid ejection nozzles/length in the sub-scanning direction of the arrangement of the treatment liquid nozzles)×100 (2)

When treatment liquid ejection nozzles and ink ejection nozzles are selected from the treatment liquid nozzles and the ink nozzles in the arrangement shown in FIG. 3, the coincidence ratio of the treatment liquid ejection nozzles and the coincidence ratio of the ink ejection nozzles can each be set to 60% by selecting upstream 80% of the treatment liquid nozzles in the sub-scanning direction and downstream 80% of the ink nozzles in the sub-scanning direction. A high usage of the ink nozzles is beneficial in terms of printing speed.

For example, when printing is performed in the first printing mode using the nozzle arrangement shown in FIG. 3, the usage of the ink ejection nozzles relative to the ink nozzles 15a to 15d may be 60% or more, 70% or more, or 80% or more. In some instances, it may be 90% or more. Beneficially, the usage of the ink ejection nozzles may be 95% or more.

The usage of the treatment liquid nozzles may be 50% or more or may be set in the same range as the usage of the ink ejection nozzles. From the viewpoint of increasing image quality, however, the usage of the treatment liquid nozzles may be 90% or less, 80% or less, 70% or less, 60% or less, or 50% or less.

When printing is performed in the second printing mode, the usage of the ink ejection nozzles relative to the ink nozzles 15a to 15d may be 70% or less, 65% or less, or 60% or less. In some instances, it may be 50% or less. The usage of the treatment liquid nozzles may be set in the same range as the usage of the ink ejection nozzles.

In the nozzle arrangements shown in FIGS. 4 and 5 as well, the usages of treatment liquid ejection nozzles and ink ejection nozzles that are effective nozzles actually used for printing are determined, and then, the treatment liquid ejection nozzles and the ink ejection nozzles are selected so that the coincidence ratio in the sub-scanning direction can be in a specific range.

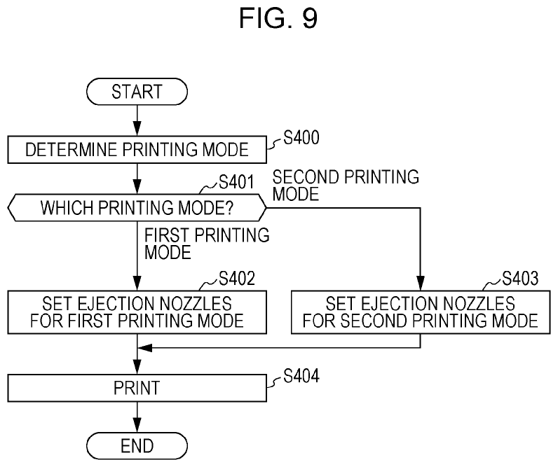

FIG. 9 is a flow chart of the operations of an ink jet printing apparatus performed for printing. To start printing, the control unit of the ink jet printing apparatus determines in Step S400 which printing mode should be used. The printing mode specifies detailed printing conditions including the conditions of the treatment liquid ejection nozzles, the ink ejection nozzles, and the like. The detailed conditions may include the proportion of the treatment liquid to be applied, which will be described later herein.

The printing mode may be determined according to a signal inputted to the ink jet printing apparatus from a computer or any other external device or user input information inputted by a user to a user input section of the ink jet printing apparatus. The signal inputted from an external device or the user input information may be a type of information that directly specifies the printing mode or may be specific data for printing that specifies the printing media to be printed, printing speed, image quality, and so forth. The specific data for printing is not limited to these. When specific data is inputted, the ink jet printing apparatus determines the printing mode according to the information corresponding to the specific data, stored in the control unit or any other device in the ink jet printing apparatus. An AI (artificial intelligence) technology may be used for the printing mode determination.

In Step S401, the determined printing mode is confirmed. In Step S402 or S403, ejection nozzles are set (selected) according to the determined printing mode. In Step S404, printing is performed. Although the printing apparatus described here has two printing mode, three or more printing modes may be available.

### 1. 3. Ink Composition

The ink composition (hereinafter often referred to as the ink) used in the ink jet printing method of the present disclosure will now be described.

The ink composition used in the embodiments according to the present disclosure is used for ink jet printing, together with the treatment liquid capable of flocculating one or more constituents of the ink composition. Aqueous ink jet ink compositions containing water as the major constituent may be used as such an ink composition.

An ink jet ink composition mentioned herein is an ink composition used in an ink jet printing method. An “aqueous” composition mentioned herein denotes a composition containing water as one of the major solvents. The water content in the ink composition may be 40% by mass or more and is beneficially 45% by mass or more, for example, 50% by mass or more or 60% by mass or more. In an embodiment, a plurality of ink compositions may be used, and the ink compositions have the same composition as each other, except that the hue angles vary among ink composition due to, for example, the use of different coloring materials.

In an embodiment, the ink composition may or may not contain an organic solvent, and the content of the organic solvent in the ink composition may be 30% by mass or less, for example, 25% by mass or less or 20% by mass or less, relative to the total mass of the ink composition. The ink composition may optionally contain a coloring material, a resin, a wax, an antifoaming agent, or a surfactant.

The constituents in the ink composition used in the embodiments according to the present disclosure will now be described.

### 1. 3. 1. Water

The ink composition disclosed herein contains water. The water is a dominant medium of the ink composition and is evaporated by drying. Beneficially, the water is pure water or ultra-pure water from which ionic impurities are removed as much as possible. Examples of such water include ion exchanged water, ultrafiltered water, reverse osmosis water, and distilled water. Sterile water prepared by, for example, UV irradiation or addition of hydrogen peroxide may be used. Sterile water can reduce the occurrence of mold or bacteria and the use thereof is beneficial for storing the aqueous ink composition for a long period.

The water content in the ink composition may be 40% by mass or more relative to the total mass of the ink composition and is beneficially 45% by mass or more, for example, 50% by mass or more or 60% by mass or more.

### 1. 3. 2. Coloring Material

The ink composition may be a color ink containing a coloring material. The ink composition may be a plurality of color ink compositions or a combination of a clear ink not containing a coloring material and one or more color inks. In an embodiment using a pale ink composition and a deep ink composition, the ink compositions may contain the same coloring material or different coloring materials.

The coloring material may be a dye or a pigment. Pigments are resistant to fading caused by light or gases and are accordingly beneficial. Images formed on a printing medium with pigment are resistant to water, gases, and light and, accordingly, can be stably stored. Such features are apparent particularly when images are formed on a poorly ink-absorbent or non-ink-absorbent printing medium.

Pigments that can be used herein include, but are not limited to, inorganic pigments and organic pigments. Exemplary inorganic pigments include titanium oxide, iron oxide, and carbon blacks produced by known methods, such as the contact method, the furnace method, and the thermal method. Exemplary organic pigments include azo pigments, polycyclic pigments, nitro pigments, nitroso pigments, and aniline black. Azo pigments include azo lake, insoluble azo pigments, condensed azo pigments, and chelate azo pigments. Polycyclic pigments include phthalocyanine pigments, perylene pigments, perinone pigments, anthraquinone pigments, and quinophthalone pigments.

The pigment used in the black ink used herein may be a carbon black. Examples of the carbon black include, but are not limited to, C.I. Pigment Black 7, such as furnace black, lampblack, acetylene black, and channel black; and commercially available carbon blacks, such as No. 2300, 900, MCF88, No. 20B, No. 33, No. 40, No. 45, No. 52, MA7, MA8, MA77, MA100, and No. 2200B (each produced by Mitsubishi Chemical); Color Blacks FW1, FW2, FW2V, FW18, FW200, S150, S160, and S170, Pritex 35, Pritex U, Pritex V, Pritex 140U, and Special Blacks 6, 5, 4A, 4, and 250 (each produced by Degussa); and Conductex SC, Raven 1255, Raven 5750, Raven 5250, Raven 5000, Raven 3500, and Raven 700 (each produced by Carbon Columbia); and Regal 400R, Regal 330R, Regal 660R, Mogul L, Monarch 700, Monarch 800, Monarch 880, Monarch 900, Monarch 1000, Monarch 1100, Monarch 1300, Monarch 1400, and Elftex 12 (each produced by Cabot).

Examples of the pigment used in the white ink include, but are not limited to, C.I. Pigment Whites 6, 18, and 21 and other inorganic white pigments, such as, titanium oxide, zinc oxide, zinc sulfide, antimony oxide, magnesium oxide, and zirconium oxide. Also, organic white pigments, apart from such inorganic white pigments, such as white hollow resin particles and polymer particles, may be used.

Pigments that can be used in a yellow ink include, but are not limited to, C.I. Pigment Yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Pigments that can be used in a magenta ink include, but are not limited to, C.I. Pigment Reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224, and 245; and C.I. Pigment Violets 19, 23, 32, 33, 36, 38, 43, and 50.

Pigments that can be used in a cyan ink include, but are not limited to, C.I. Pigment Blues 1, 2, 3, 15, 15:1, 15:2, 15:3, 15:34, 15:4, 16, 18, 22, 25, 60, 65, and 66; and C.I. Vat Blues 4 and 60.

Pigments that can be used in color inks other than magenta, cyan, and yellow include, but are not limited to, C.I. Pigment Greens 7 and 10, C.I. Pigment Browns 3, 5, 25, and 26, and C.I. Pigment Oranges 1, 2, 5, 7, 13, 14, 15, 16, 24, 34, 36, 38, 40, 43, and 63.

Examples of pearl pigments include, but are not limited to, pigments exhibiting pearly gloss or interference gloss, such as titanium dioxide-coated mica, fish scale foil, and bismuth trichloride.

Examples of metal pigments include, but are not limited to, elemental metals, such as aluminum, silver, gold, platinum, nickel, chromium, tin, zinc, indium, titanium, and copper, and alloys thereof.

The lower limit of the coloring material content in the color inks may be 0.5% by mass or more, for example, 1% by mass or more or 3% by mass or more, relative to the total mass of the ink composition. In addition, the upper limit of the coloring material content in the color inks may be 10% by mass or less, for example, 7% by mass or less or 6% by mass or less, relative to the total mass of the ink composition. When the coloring material content is in such a range, images formed on a printing medium are resistant to water, gases, light, and the like and, accordingly, can be stably stored.

When a combination of a pale ink composition and a deep ink composition that are of the same color type having different color densities is used, the coloring material content in the deep ink composition may be higher than that in the pale ink composition by 1% by mass or more, for example, 2% by mass or more or 3% by mass or more. When the deep ink composition and the pale ink composition have such a difference in coloring material content, high-quality images with favorable gradation can be printed.

In such a combination, the coloring material content in the pale ink composition may be 1.5% by mass or less relative to the total mass of the ink composition and, for example, may be 1% by mass or less, 0.8% by mass or less, 0.6% by mass or less, or 0.5% by mass or less. The lower limit in this case may be, but is not limited to, 0.05% by mass or more, 0.1% by mass or more, or 0.3% by mass or more.

In this combination, the lower limit of the coloring material content in the deep ink composition may be more than 1.5% by mass, for example, 2.0% by mass or more or 3.0% by mass or more, relative to the total mass of the ink composition. Also, the upper limit in this case may be 10% by mass or less, for example, 7% by mass or less or 6% by mass or less, relative to the total mass of the ink composition.

When a pigment is used as the coloring material, the pigment may be in the form of a dispersion liquid. The pigment dispersion liquid contains a pigment and a solvent and optionally a dispersant. The solvent may be water or a hydrophilic solvent, such as diethylene glycol. The dispersant may be a styrene-acrylic acid copolymer. The acid value of the dispersant may be, but is not limited to, 20 mg KOH/g or more from the viewpoint of uniformly dispersing the pigment.

When a clear ink is used as one of the ink compositions, the coloring material content in the clear ink may be 0.2% by mass or less, for example, 0.1% by mass or less or 0.05% by mass or less, and the lower limit thereof may be 0% by mass. The clear ink is not intended to color the printing medium and is used for other purposes. For example, the clear ink may be used, but is not limited to, to increase the rub fastness and other properties of the printed item, to adjust the gloss of the printing medium, to fix color inks, or to improve color development. In addition, the clear ink is not the treatment liquid described later herein and, therefore, contains no flocculant.

### 1. 3. 3. Organic Solvent

The ink composition used in some embodiments according to the present disclosure may contain an organic solvent. The organic solvent facilitates stable ejection of the ink composition. In addition, the organic solvent helps the ink composition ejected onto the printing medium to dry satisfactorily and thus to form high-quality images having a high rub fastness.

The organic solvent used in the ink composition may be a water-soluble organic solvent. Inks containing a water-soluble organic solvent can be readily dried and, thus, can form high-quality images having a high rub fastness.

Examples of the water-soluble organic solvent include, but are not limited to, alkanediols, polyols, nitrogen-containing solvents, esters, glycol ethers, and cyclic esters.

Exemplary alkanediols include 1,2-alkanediols, such as ethylene glycol, propylene glycol, 1,2-propanediol, 1,2-butanediol, 1,2-pentanediol, 1,2-hexanediol, and 1,2-octanediol, 1,3-propanediol, and 1,4-butanediol, 1,6-hexanediol. Such alkanediols may be used individually or in combination. Alkanediols are beneficial for increasing the wettability of the ink composition on the printing medium and helping the ink composition to penetrate the printing medium. In particular, 1,2-alkanediols are beneficial for helping penetration and may be often used as the organic solvent. The alkanediol used in the ink composition may be a diol of an alkane having a carbon number of 5 or more. The alkane may be linear or branched, and the carbon number thereof may be from 5 to 9.

Exemplary polyols include diethylene glycol, triethylene glycol, dipropylene glycol, 2-ethyl-2-methyl-1,3-propanediol, 2-methyl-2-propyl-1,3-propanediol, 2-methyl-1,3-propanediol, 2,2-dimethyl-1,3-propanediol, 3-methyl-1,3-butanediol, 2-ethyl-1,3-hexanediol, 3-methyl-1,5-pentanediol, 2-methylpentane-2,4-diol, trimethylolpropane, and glycerin. Such polyols may be used individually or in combination. Polyols are beneficial as moisturizer. The polyol used in the ink composition may be a compound formed by binding two or more hydroxy groups to an alkane having a carbon number of 4 or less, or a compound formed by 2 to 4 intermolecular condensations of some of the hydroxy groups of compounds formed by binding two or more hydroxy groups to an alkane having a carbon number of 4 or less. Polyols are compound having two or more hydroxy groups in the molecule thereof. In some embodiments according to the present disclosure, the number of hydroxy groups may be 2 or 3.

Exemplary nitrogen-containing solvents include pyrrolidones, such as N-methyl-2-pyrrolidone, N-ethyl-2-pyrrolidone, N-vinyl-2-pyrrolidone, 2-pyrrolidone, N-butyl-2-pyrrolidone, and 5-methyl-2-pyrrolidone. Such solvents may be used individually or in combination. Nitrogen-containing solvents, which act as a dissolving agent favorable to resin, help the ink composition to produce printed items having high fastness to rubbing and prevent the ink composition from clogging the nozzles of the ink jet head.

The nitrogen-containing solvent may be an alkoxyalkylamide, and examples thereof include 3-methoxy-N,N-dimethylpropionamide, 3-methoxy-N,N-diethylpropionamide, 3-methoxy-N,N-methylethylpropionamide, 3-ethoxy-N,N-dimethylpropionamide, 3-ethoxy-N,N-diethylpropionamide, 3-ethoxy-N,N-methylethylpropionamide, 3-n-butoxy-N,N-dimethylpropionamide, 3-n-butoxy-N,N-diethylpropionamide, 3-n-butoxy-N,N-methylethylpropionamide, 3-n-propoxy-N,N-dimethylpropionamide, 3-n-propoxy-N,N-diethylpropionamide, 3-n-propoxy-N,N-methylethylpropionamide, 3-iso-propoxy-N,N-dimethylpropionamide, 3-iso-propoxy-N,N-diethylpropionamide, 3-iso-propoxy-N,N-methylethylpropionamide, 3-tert-butoxy-N,N-dimethylpropionamide, 3-tert-butoxy-N,N-diethylpropionamide, and 3-tert-butoxy-N,N-methylethylpropionamide.

In an embodiment, an amide-based solvent may be used as the nitrogen-containing solvent. The amide-based solvent may be a cyclic amide-based solvent or an acyclic amide-based solvent. The cyclic amide-based solvent may be any one of the above-cited pyrrolidines. The acyclic amide-based solvent may be any one of the above-cited alkoxyalkylamides.

The content of the nitrogen-containing solvent in the ink composition may be from 3% by mass to 30% by mass, for example, from 5% by mass to 25% by mass or from 10% by mass to 20% by mass. The ink containing a nitrogen-containing solvent is beneficial for improving rub fastness, image quality, and the like.

Exemplary esters include glycol monoacetates, such as ethylene glycol monomethyl ether acetate, ethylene glycol monoethyl ether acetate, ethylene glycol monobutyl ether acetate, diethylene glycol monomethyl ether acetate, diethylene glycol monoethyl ether acetate, diethylene glycol monobutyl ether acetate, propylene glycol monomethyl ether acetate, dipropylene glycol monomethyl ether acetate, and methoxybutyl acetate; and glycol diesters, such as ethylene glycol diacetate, diethylene glycol diacetate, propylene glycol diacetate, dipropylene glycol diacetate, ethylene glycol acetate propionate, ethylene glycol acetate butylate, diethylene glycol acetate butylate, diethylene glycol acetate propionate, diethylene glycol acetate butylate, propylene glycol acetate propionate, propylene glycol acetate butylate, dipropylene glycol acetate butylate, and dipropylene glycol acetate propionate.

Exemplary glycol ethers include alkylene glycol monoethers and alkylene glycol diethers. In some embodiments, an alkyl ether may be used. More specifically, examples of such an alkylene glycol ether include alkylene glycol monoalkyl ethers, such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, and tripropylene glycol monobutyl ether; and alkylene glycol dialkyl ethers, such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methylethyl ether, diethylene glycol methylbutyl ether, triethylene glycol dimethyl ether, triethylene glycol diethyl ether, triethylene glycol dibutyl ether, triethylene glycol methylbutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether. Glycol ethers are beneficial for controlling the wettability of the ink composition on the printing medium.

In some embodiments, alkylene glycol dieters may be more beneficial than alkylene glycol mono ethers. Alkylene glycol diethers are more likely to dissolve the resin in the ink or to swell the resin, thus increasing the rub fastness of the resulting image.

Exemplary cyclic esters include lactones, such as β-propiolactone, γ-butyrolactone, δ-valerolactone, ε-caprolactone, β-butyrolactone, β-valerolactone, γ-valerolactone, β-hexanolactone, γ-hexanolactone, δ-hexanolactone, β-heptanolactone, γ-heptanolactone, δ-heptanolactone, ε-heptanolactone, γ-octanolactone, δ-octanolactone, ε-octanolactone, δ-nanolactone, ε-nanolactone, and ε-decanolactone; and compounds derived from these lactones by substituting an alkyl group having a carbon number of 1 to 4 for the hydrogen of the methylene group adjacent to the carbonyl group of the lactone.

The organic solvent content may be 1% by mass or more, for example, 5% by mass or more or 10% by mass or more, relative to the total mass of the ink composition. Also, the organic solvent content may be 40% by mass or less, for example, 35% by mass or less or 30% by mass or less, relative to the total mass of the ink composition. Ink compositions containing an organic solvent with such a content are unlikely to cause clogging and help produce printed items having a high rub fastness.

The normal boiling point of the organic solvent may be 180° C. or more, for example, 200° C. or more or 210° C. or more. Also, the normal boiling point of the organic solvent may be 300° C. or less, for example, 270° C. or less or 250° C. or less. Ink compositions containing an organic solvent having such a normal boiling point are unlikely to cause clogging and help produce printed items having a high rub fastness.

Polyols having a normal boiling point of more than 280° C., such as triethylene glycol and glycerin, act as a moisturizing agent, and accordingly, the ink composition containing such a polyol does not much dry the ink jet head and thus reduce clogging. However, polyols having a normal boiling point of more than 280° C. absorb water from the ink composition and are thus likely to increase the viscosity of the ink composition around the ink jet head or cause the ink applied onto the printing medium to become difficult to dry. Accordingly, the upper limit of the polyol content having a normal boiling point of more than 280° C. in the ink composition is beneficially 3% by mass or less, for example, 2% by mass or less or 1% by mass or less. In some embodiments, it may be 0.8% by mass or less or 0.1% by mass or less. Such an ink composition can dry rapidly on the printing medium and is accordingly suitable to print images on poorly absorbent printing media or non-absorbent printing media and can produce images exhibit having a high rub fastness. In view of this, in addition, it is beneficial to control the content of the organic solvent (not limited to polyols) having a normal boiling point of more than 280° C. to the foregoing range.

### 1. 3. 4. Resin

The ink composition used in some embodiments according to the present disclosure may contain a resin. The resin solidifies the ink composition and firmly fixes the solidified ink to the printing medium. The resin may be dissolved or dispersed in the ink composition. For dissolving the resin, the above described resin dispersant used for dispersing the pigment in the ink composition may be used. The resin in the form of dispersion may be an emulsion or a suspension. The emulsion or the suspension may be prepared by dispersing fine particles of a resin that is insoluble or poorly soluble in the liquid medium of the ink.

Examples of the resin used in the ink composition include, but are not limited to, acrylic resin, vinyl acetate resin, polyvinyl chloride resin, butadiene resin, styrene resin, polyester resin, crosslinked acrylic resin, crosslinked styrene resin, benzoguanamine resin, phenol resin, silicone resin, epoxy resin, urethane resin, paraffin resin, fluororesin, and water-soluble resin, and copolymers of monomers forming these resins. Examples of the copolymers include, but are not limited to, styrene-butadiene resin and styrene-acrylic resin. A polymer latex containing one or more of these resins may be used as the resin. For example, a polymer latex containing fine particles of a resin, such as acrylic resin, styrene-acrylic resin, styrene resin, crosslinked acrylic resin, or crosslinked styrene resin, may be used. The resins cited above may be used individually or in combination.

Acrylic resin is a homopolymer or a copolymer formed by polymerizing one or more acrylic monomers. Acrylic monomers include (meth)acrylates, (meth)acrylic acid, acrylamide, and acrylonitrile. The acrylic resin in a copolymer form may be an acrylic-vinyl resin that is formed by using a vinyl monomer as the other monomer, for example, a styrene-acrylic resin formed by using styrene as the vinyl monomer. Acrylic resin, urethane resin, and polyester resin are more available than other resins and beneficial for obtaining a resin having desired properties.

The lower limit of the resin solid content may be 1% by mass or more, for example, 2% by mass or more or 3% by mass or more, relative to the total mass of the ink composition. The upper limit of the resin solid content may be 15% by mass or less, for example, 10% by mass or less or 7% by mass or less, relative to the total mass of the ink composition. The ink composition containing a resin with such a content is unlikely to cause clogging and can form images having a high rub fastness even on a poorly ink-absorbent or non-ink-absorbent printing medium.

### 1. 3. 5. Surfactant

The ink composition used in some embodiments according to the present disclosure may contain a surfactant. Examples of the surfactant include, but are not limited to, acetylene glycol-based surfactants, fluorosurfactants, and silicone surfactants. The ink composition may contain at least one of these surfactants, particularly, an acetylene glycol-based surfactant or a silicone surfactant. The silicone surfactant or the acetylene glycol surfactant in the ink composition reduces the dynamic surface tension of the ink and makes the ink unlikely to cause clogging.

Examples of the acetylene glycol-based surfactant include, but are not limited to, SURFYNOL series 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (each produced by Air Products and Chemicals); OLFINE series B, Y, P, A, STG, SPC, E1004, E1010, PD-001, PD-002W, PD-003, PD-004, EXP. 4001, EXP. 4036, EXP. 4051, AF-103, AF-104, AK-02, SK-14, and AE-3 (each produced by Nissin Chemical Industry); and ACETYLENOL series E00, E00P, E40, and E100 (each produced by Kawaken Fine Chemicals).

The silicone surfactant may be, but is not limited to, a polysiloxane-based compound. For example, a polyether-modified organosiloxane may be used as the polysiloxane-based compound. Polyether-modified organosiloxanes are commercially available, and examples thereof include BYK-306, BYK-307, BYK-333, BYK-341, BYK-345, BYK-346, and BYK-348 (each produced by BYK); KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (each produced by Shin-Etsu Chemical); and SILFACE SAG503A and SILFACE SAG014 (each produced by Nissin Chemical Industry).

The fluorosurfactant used in the ink composition may be a fluorine-modified polymer, such as BYK-340 (produced by BYK).

When a surfactant is added to the ink composition, the surfactant content may be from 0.1% by mass to 1.5% by mass relative to the total mass of the ink composition.

### 1. 3. 6. Wax

The ink composition used in some embodiments according to the present disclosure may contain a wax. The wax may be dissolved in the ink composition or be in the form of emulsion in which fine particles thereof are dispersed. The use of such a wax tends to be helpful to increase the rub fastness of the printed item. In particular, the wax tends to be locally present at the surface of the coating of the ink, that is, at the interface between the air and the coating, on the printing medium, thus contributing to increasing the rub fastness. The wax may be, but is not limited to, an ester wax made up of a higher fatty acid and a higher monohydric or dihydric alcohol, a paraffin wax, a microcrystalline wax, a polyolefin wax, or a mixture thereof.

The polyolefin wax may be a wax or a copolymer of the wax produced from an olefin, such as ethylene, propylene, or butylene, or an olefin derivative, and examples of the polyolefin wax include polyethylene waxes, polypropylene waxes, and polybutylene waxes. A commercially available polyolefin wax may be used, and examples thereof include NOPCOTE PEM 17 (produced by San Nopco), CHEMIPEARL W4005 (produced by Mitsui Chemicals), and AQUACER 515 and AQUACER 593 (each produced by BYK).

The wax content in the ink composition may be from 0.1% by mass to 5% by mass, for example, from 0.2% by mass to 4% by mass or 0.3% by mass to 3% by mass, relative to the total mass of the ink composition. When the wax content is in such a range, the ink composition can improve the rub fastness of the printed image, and the ink composition has a low viscosity and, accordingly, can be stably ejected and helps nozzles recover from clogging.

### 1. 3. 7. Antifoaming Agent

Examples of the antifoaming agent include, but are not limited to, silicone antifoaming agents, polyether antifoaming agents, fatty acid ester antifoaming agents, and acetylene glycol antifoaming agents. The antifoaming agent is commercially available, and examples thereof include BYK-011, BYK-012, BYK-017, BYK-018, BYK-019, BYK-020, BYK-021, BYK-022, BYK-023, BYK-024, BYK-025, BYK-028, BYK-038, BYK-044, BYK-080A, BYK-094, BYK-1610, BYK-1615, BYK-1650, BYK-1730, and BYK-1770 (each produced by BYK); and Surfynol series DF37, DF110D, DF58, DF75, DF220, and MD-20 and Enviro Gem ADO1 (each produced by Air Products and Chemicals). Such antifoaming agents may be used individually or in combination.

The antifoaming agent content in the ink composition may be from 0.03% by mass to 0.7% by mass, for example, from 0.05% by mass to 0.5% by mass or 0.08% by mass to 0.3% by mass, relative to the total mass of the ink composition.

### 1. 3. 8. Other Constituents

The ink composition disclosed in an embodiment according to the present disclosure may optionally contain a solubilizing agent, a viscosity modifier, a pH adjuster, an antioxidant, a preservative, an antifungal agent, a corrosion inhibitor, a moisturizing agent that does not act as an organic solvent, and a chelating agent for capturing metal ions affecting dispersion, and other additives, from the viewpoint of maintaining stability in storage and ejection from the ink jet head, suppressing clogging, and preventing deterioration.

### 1. 3. 9. Preparation of Ink Composition

The ink composition described herein are prepared by mixing the above-described constituents in a desired order and, optionally, removing impurities by, for example, filtration. For mixing the constituents, for example, the constituents may be added one after another into a container equipped with a stirring device, such as a mechanical stirrer or a magnetic stirrer, and the contents of the container are stirred. Filtration may be performed as required by, for example, centrifugal filtration or using a filter paper.

### 1. 3. 10. Properties of Ink Composition

Beneficially, the ink composition used in the present disclosure have a surface tension from 18 mN/m to 40 mN/m at 20° C., for example, from 20 mN/m to 35 mN/m or from 22 mN/m to 33 mN/m, from the viewpoint of the balance between the quality of the resulting image and the reliability of the ink composition as an ink jet ink. The surface tension can be determined by measuring the ink composition wetting a platinum plate at 20° C. with, for example, an automatic surface tensiometer CBVP-Z (manufactured by Kyowa Interface Science).

Also, from the same viewpoint as above, the viscosity of the ink composition may be from 3 mPa·s to 10 mPa·s at 20° C., for example, from 3 mPa·s to 8 mPa·s. The viscosity can be measured at 20° C. with a viscoelasticity meter MCR-300 (manufactured by Pysica).

### 1. 4. Treatment Liquid

The treatment liquid used in the embodiments according to the present disclosure will now be described.

The treatment liquid used herein is a composition used to flocculate one or more constituents of the ink composition and may contain a flocculant capable of flocculate the constituents. The treatment liquid reacts with the coloring material, the resin, or the like contained in the ink. The coloring material content in the treatment liquid may be 0.2% by mass or less, 0.1% by mass or less, or 0.05% by mass or less. The lower limit of the coloring material content is 0% by mass. Unlike the above-described ink, the treatment liquid is not an ink used to color the printing medium and is an aid that is applied onto the printing medium before or simultaneously with applying the ink.

The treatment liquid may contain other constituents with a desired content and have any properties, independent of the ink composition, provided that it contains a flocculant. The treatment liquid is beneficial for printing high-quality images. However, the use of the treatment liquid may lead to a reduced rub fastness or make clogging more likely to occur.

### 1. 4. 1. Flocculant

The treatment liquid used herein may contain a flocculant that flocculates one or more constituents of the ink composition. The flocculant in the treatment liquid reacts rapidly with the coloring material, the resin, and the like in the ink composition in the step of applying ink described later herein. Thus, the coloring material and the resin dispersed in the ink composition are flocculated. The flocculate inhibits the coloring material from penetrating the printing medium, thus improving the image quality of the printed image.

The flocculant may be a multivalent metal salt, a cationic compound, such as a cationic resin or a cationic surfactant, or an organic acid. Such a flocculant may be used individually, or some flocculants may be used in combination. In some embodiments, the flocculant may be at least one selected from the group consisting of multivalent metal salts, organic acids, and cationic resins because such compounds are highly reactive with the constituents in the ink composition.

The multivalent metal salt may be a water-soluble compound composed of a divalent or higher-valent metal ion and an anion capable of binding to the metal ion. Examples of the multivalent metal ion include divalent metal ions, such as Ca²⁺, cu²⁺, Ni²⁺, Mg²⁺, Zn²⁺, and Ba²⁺; and trivalent metal ions, such as Al³⁺, Fe³⁺, and Cr³⁺. Examples of the anion include Cl⁻, I⁻, Br⁻, SO₄²⁻, ClO₃⁻, NO₃⁻, HCOO⁻, and CH₃COO⁻. Calcium salts and magnesium salts are beneficial in terms of stability of the treatment liquid and reactivity of the treatment liquid as the flocculant.

Examples of the organic acid include phosphoric acid, polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furancarboxylic acid, pyridinecarboxylic acid, coumaric acid, thiophenecarboxylic acid, nicotinic acid, and derivatives or salts of these acids. Such organic acids may be used individually or in combination. Organic acid salts of multivalent metals belong to the category of the above-described multivalent metal salts.

Examples of the cationic resin include cationic urethane resin, cationic olefin resin, and cationic amine-based resin. The cationic amine-based resin has an amino group, and examples thereof include allylamine resin, polyamine resin, and quaternary ammonium salt polymer. The polyamine resin may be a resin having an amino group in the main skeleton of the resin. The allylamine resin may be a resin having a structure derived from the allyl group in the main skeleton of the resin. The quaternary ammonium salt polymer may be a resin having a quaternary ammonium salt in the structure thereof. Cationic amine-based resin is superior in reactivity and availability to other cationic resins and is therefore often used.

The flocculant content in the treatment liquid may be 0.5% by mass or more, for example, 1% by mass or more or 3% by mass or more, relative to the total mass of the treatment liquid. Also, the flocculant content in the treatment liquid may be 15% by mass or less, for example, 10% by mass or less or 5% by mass or less, relative to the total mass of the treatment liquid.

### 1. 4. 2. Water

In some embodiments, the treatment liquid may be an aqueous composition containing water as a major solvent. The water will be evaporated by drying after the treatment liquid has been applied onto the printing medium. The water may be pure water or ultra-pure water from which ionic impurities have been removed as much as possible. Examples of such water include ion exchanged water, ultrafiltered water, reverse osmosis water, and distilled water. Sterile water prepared by, for example, UV irradiation or addition of hydrogen peroxide is beneficial. The use of sterile water can prevent, for a long period, the occurrence of mold or bacteria in the treatment liquid. The water content in the treatment liquid may be 40% by mass or more relative to the total mass of the treatment liquid and is, for example, 50% by mass or more, 60% by mass or more, or 70% by mass or more.

### 1. 4. 3. Organic Solvent

The treatment liquid may contain an organic solvent. By adding an organic solvent, the wettability of the treatment liquid on the printing medium can be increased. The organic solvent may be selected from the organic solvents cited as those used in the ink composition. The organic solvent content may be, but is not limited to, from 10% by mass to 80% by mass, for example, from 15% by mass to 70% by mass, relative to the total mass of the treatment liquid.

The normal boiling point of the organic solvent used in the treatment liquid may be in the range described for the organic solvent that can be used in the ink composition, and the organic solvent may be selected independently of the organic solvent used in the ink composition. Alternatively, the normal boiling point of the organic solvent used in the treatment liquid may be 180° C. or more, for example, 190° C. or more or 200° C. or more. Also, the normal boiling point of the organic solvent may be 300° C. or less, for example, 270° C. or less or 250° C. or less.

As with the ink composition, the treatment liquid may contain a polyol having a normal boiling point of 280° C. or more as the organic solvent with a content of 5% by mass or less or 3% by mass or less, for example, 2% by mass or less or 1% by mass or less. In some embodiments, the content of such an organic solvent may be 0.8% by mass or less or 0.1% by mass or less. Such a treatment liquid can dry easily and rapidly. Accordingly, the resulting printed article is unlikely to be sticky and is superior in rub fastness. In view of this, in addition, it is beneficial to control the content of the organic solvent (not limited to polyols) having a normal boiling point of more than 280° C. to the foregoing range.

### 1. 4. 4. Surfactant

The treatment liquid may contain a surfactant. By adding a surfactant, the surface tension of the treatment liquid can be reduced, and accordingly, the wettability of the treatment liquid on the printing medium can be increased. In some embodiments, an acetylene glycol-based surfactant, a silicone surfactant, or a fluorosurfactant may be selected from among the surfactants. Examples of the surfactant that may be used in the treatment liquid are the same as those cited for the ink composition. The surfactant content may be, but is not limited to, 0.1% by mass to 5% by mass relative to the total mass of the treatment liquid.

### 1. 4. 5. Other Constituents

The treatment liquid used herein may optionally contain a pH adjuster, a preservative or a fungicide, a rust preventive, a chelating agent, and other additives as described above.

### 1. 4. 6. Preparation of Treatment Liquid

The treatment liquid used herein may be prepared by mixing and dispersing the above-described constituents in an appropriate manner. After sufficiently stirring the mixture, foreign matter and coarse particles that may cause clogging are removed through a filter to yield a desired treatment liquid.

### 1. 4. 7. Physical Properties of Treatment Liquid

When the treatment liquid is applied by being ejected from an ink jet head, the surface tension of the treatment liquid at 20° C. is beneficially from 18 mN/m to 40 mN/m, from 20 mN/m to 35 mN/m, or from 22 mN/m to 33 mN/m. The surface tension may be determined by measuring the treatment liquid wetting a platinum plate at 20° C. with, for example, an automatic surface tensiometer CBVP-Z (product name, manufactured by Kyowa Interface Science).

In addition, from the same viewpoint as just mentioned, the viscosity of the treatment liquid at 20° C. may be from 3 mPa·s to 10 mPa·s or from 3 mPa·s to 8 mPa·s. The viscosity can be measured at 20° C. with, for example, a viscoelasticity meter MCR-300 (manufactured by Pysica).

### 1. 5. Printing Medium

The ink jet printing apparatus disclosed herein can print high-quality images having a high rub fastness on poorly ink-absorbent or non-ink-absorbent printing media. In particular, combined use of one or more inks and the treatment liquid enables high-quality images having a high rub fastness to be printed on non-ink-absorbent or poorly ink-absorbent printing media.

Examples of ink-absorbent printing media include cloths of ink absorbent material, such as cotton, silk, polyester, polyurethane, and nylon, plain paper, ink jet paper, moderately absorbent fine quality paper, recycled plain paper, copy paper, and ink jet paper having an ink-receiving layer capable of absorbing ink.

The poorly ink-absorbent printing medium may be provided with a coating layer capable of receiving ink on the surface thereof. The base material of such a poorly ink-absorbent printing medium may be paper or a plastic film made of polyvinyl chloride, polyethylene terephthalate, polycarbonate, polystyrene, polyurethane, polyethylene, polypropylene, or the like. Examples of the paper-base printing medium may be a book-printing paper, such as art paper, coated paper, or matte paper. The plastic film-base printing medium is coated with a hydrophilic polymer or silica or titanium particles applied together with a binder.

The non-ink-absorbent printing medium may be a plastic film not surface-treated for ink jet printing (not having an ink-absorbing layer), or a paper sheet or any other medium coated with or bonded to a plastic film. The term plastic mentioned here may be polyvinyl chloride, polyethylene terephthalate, polycarbonate, polystyrene, polyurethane, polyethylene, or polypropylene.

The poorly ink-absorbent and non-ink-absorbent printing medium used herein refer to a printing media that can absorb water in an amount of 10 mL/m² or less for a period of 30 ms^{1/2} from the beginning of contact with water, measured by Bristow's method. Bristow's method is broadly used for measuring liquid absorption in a short time, and Japan Technical Association of the Pulp and Paper Industry (JAPAN TAPPI) officially adopts this method. Details of this method are specified in Standard No. 51 (Paper and Paperboard—Liquid Absorption Test Method—Bristow's Method (in Japanese)) of JAPAN TAPPI Paper and Pulp Test Methods edited in 2000 (in Japanese).

The printing medium may be translucent or transparent. Also, poorly ink-absorbent or non-ink-absorbent media having an uneven surface, such as embossed media may be used.

### 2. Ink Jet Printing Method

The ink jet printing method according to the present disclosure is a serial printing method using the above-described ink jet printing apparatus including an ink jet head. More specifically, this method includes a printing step of performing a plurality of times of scanning that is an operation performed by ejecting a treatment liquid and an ink composition from an ink jet head that is being transferred in a scanning direction to apply the treatment liquid and the ink composition onto a printing medium; and a transport step of transporting the printing medium in a sub-scanning direction intersecting the scanning direction. Thus, printing is performed by alternately repeating: the scanning operation of ejecting ink from the ink jet head to apply the ink onto the printing medium while the ink jet head is being transferred across the printing medium in the scanning direction; and the transport operation (sub-scanning) of transporting the printing medium in the sub-scanning direction.

In the serial printing method, the number of times of scanning refers to the number of passes of the nozzles filled with a composition over a position to be printed of a printing medium in a manner opposing the printing medium. The number of times of scanning is set for each composition. For example, when a group or line of the nozzles shown in FIG. 3 is filled with an ink and used for printing and the distance of one sub-scan is a half of the length of the nozzle group in the sub-scanning direction, the number of times of scanning using this nozzle group is two. The number of times of scanning can be increased by reducing the distance of one sub-scan in the sub-scanning direction and can be reduced by increasing the distance. When the number of times of scanning is large, a large amount of composition can be applied in total, and a certain amount of a composition can be applied by a plurality of times of scanning. In contrast, when the number of times of scanning is small, the printing speed is increased. The number of times of scanning may be referred to as the number of passes. In the present disclosure, the number of times of scanning is in terms of the nozzles through which compositions are actually ejected for printing, that is, in terms of the ejection nozzles.

In the ink jet printing method disclosed herein, the maximum distance of one scan (one time of scanning) may be 50 cm or more. The “maximum distance of one scan” mentioned herein is the distance of the movement of a point of the ink jet head opposing the printing medium when printing is performed across the printing medium from one end in the scanning direction to the other in one scan. The maximum distance of one scan may be from 50 cm to 500 cm, from 50 cm to 400 cm, from 55 cm to 300 cm, or from 60 cm to 200 cm. In some embodiments, it may be from 70 cm to 190 cm, from 100 cm to 180 cm, or from 130 cm to 170 cm. When the maximum distance of one scan is 50 cm or more, display-intended printed items can be favorably produced. The upper limit of the maximum distance may be, but is not limited to, 500 cm or less in view of the structure of the printing apparatus. When an image is printed, scanning may be performed a shorter distance than the maximum distance of one scan according to the image.

Beneficially, the width of the printing medium, that is, the distance of the printing medium in the scanning direction, is in the above-described range of the maximum distance. In this instance, the maximum distance of one scan can be in the above-described range.

The ink jet printing method disclosed herein includes the printing step including a treatment liquid application step and an ink application step that are performed by the above-described scanning operation, and optionally a secondary heating step.

### 2. 1. Treatment Liquid Application Step

In the treatment liquid application step, the treatment liquid capable of reacting with the ink composition is applied onto a printing medium. By applying the treatment liquid onto the printing medium, the rub fastness and the image quality of the printed image can be improved.

The treatment liquid may be applied before or simultaneously with applying the ink composition. In the embodiment using the nozzle arrangement shown in FIG. 3, the treatment liquid application step is performed simultaneously with the ink application step described later herein. In the embodiment using the nozzle arrangement shown in FIG. 4, a part of the treatment liquid application step is performed before the ink application step, and the rest of the treatment liquid application step is performed simultaneously with the ink application step.

In the embodiments using any of the nozzle arrangements shown in FIGS. 3 to 8, when printing is performed in the first printing mode, in which the coincident portion of the arrangement of the treatment liquid ejection nozzles coincident in position with the arrangement of the ink ejection nozzles accounts for 60% or more of the length in the sub-scanning direction of the arrangement of the treatment liquid ejection nozzles, the treatment liquid is applied onto a region of the printing medium 10 in a higher proportion than in the second printing mode relative to the ink composition applied onto the region of the printing medium. The proportion of the treatment liquid to the ink composition in the first printing mode may be 1.2 times or more the proportion in the second printing mode. Beneficially, it may be 1.5 times or more or 1.8 or more. Also, the upper limit of such a proportion may be 3 times or less, 2.5 times or less, or 2.2 times or less.

Also, the treatment liquid may be applied in a proportion of from 20% by mass to 50% by mass, for example, from 20% by mass to 40% by mass or from 25% by mass to 35% by mass, relative to the ink composition applied onto the same region. When the treatment liquid and the ink composition are applied in such a proportion, more high-quality images can be formed on a poorly absorbent or non-absorbent printing medium, and the rub fastness of the resulting images can be prevented from decreasing.

Applying the treatment liquid in a specific proportion (value in percent by mass) relative to the ink composition implies that the region of the printing medium onto which the treatment liquid and the ink composition are applied include an area that receives the treatment liquid and the ink composition in the specific proportion.

Beneficially, in the region onto which the ink composition and the treatment liquid are applied, the area that receives the largest amount of the ink composition receives the treatment liquid and the ink composition in a proportion cited above. Also, in the region onto which the ink composition and the treatment liquid are applied, the area that receives the treatment liquid in the largest proportion relative to the ink composition may receive the treatment liquid and the ink composition in a proportion cited above.

The proportion of the treatment liquid to be applied is set for each printing mode by the control unit of the ink jet printing apparatus, and the treatment liquid is applied for printing in the set proportion.

In the embodiments using any of the nozzle arrangements shown in FIGS. 3 to 8, when printing is performed in the second printing mode, in which the coincident portion of the arrangement of the treatment liquid ejection nozzles coincident in position with the arrangement of the ink ejection nozzles accounts for 50% or less of the length in the sub-scanning direction of the arrangement of the treatment liquid ejection nozzles, the treatment liquid is applied onto a region of the printing medium 10 in a lower proportion than in the first printing mode relative to the ink composition applied to the region of the printing medium, for example, in a proportion of from 5% by mass to 25% by mass or from 7% by mass to 20% by mass. In some embodiments, it may be from 8% by mass to less than 20% by mass or from 10% by mass to 15% by mass. When the treatment liquid and the ink composition are applied in such a proportion in the second printing mode, higher quality images can be formed on a variety of printing media, and the rub fastness of the resulting images can be prevented from decreasing.

When the proportions (or amount) of the treatment liquid applied in the first printing mode and in the second printing mode are discussed, the proportions of the treatment liquid are beneficially those when the treatment liquid is applied onto the same type of printing medium.

The printing medium 10 may be heated before the treatment liquid application step with the preheater 7 shown in FIG. 1 or during the treatment liquid application step with the IR heater 3 or the platen heater 4 shown in FIG. 1. The treatment liquid applied onto the heated printing medium 10 becomes likely to spread on the printing medium 10, thus being uniformly applied. Consequently, the treatment liquid can react sufficiently with the ink composition applied in the ink application step described later herein to provide favorable image quality. In addition, since the treatment liquid thus can be uniformly applied onto the printing medium 10, the amount of treatment liquid to be applied is reduced, and the rub fastness of the resulting image is prevented from decreasing.

The surface temperature of the printing medium 10 when the treatment liquid is applied thereto may be set independent of the range of the surface temperature (primary heating temperature) of the printing medium 10 when inks are applied thereto. The surface temperature of the printing medium 10 when the treatment liquid is applied thereto may be 45° C. or less, for example, 40° C. or less or 38° C. or less. The lower limit of the surface temperature of the printing medium 10 when the treatment liquid is applied thereto may be 25° C. or more, for example, 30° C. or more. When the surface temperature of the printing medium 10 is in such a range, the treatment liquid can be uniformly applied onto the printing medium 10 to increase the rub fastness and image quality of the printed image. In addition, the impact of heat on the ink jet head 2 is reduced.

### 2. 2. Ink Application Step

In the ink application step, the above-described ink composition is ejected from the ink jet head 2 and applied onto the printing medium 10, thus forming an image on the surface of the printing medium 10.

The maximum rate of application amount of the ink composition onto the printing medium 10 may be 5 mg/inch² or more, for example, 7 mg/inch² or more or 10 mg/inch² or more. The upper limit of the application amount of the ink composition may be, but is not limited to, 20 mg/inch² or less or 18 mg/inch² or less, for example, 16 mg/inch² or less. The maximum rate of application amount of the ink composition is the total mass of the ink compositions superimposed per unit area.

The printing medium 10 may be heated before the ink application step or simultaneously with the ink application step, and it is beneficial to apply the ink composition onto the printing medium 10 heated by such heating. This heating may be performed with an IR heater 3 or a platen heater 4 or by blowing of warm air to the printing medium with a fan or the like. By heating the printing medium 10, the ink is rapidly heated on the printing medium, thereby reducing bleeding. In addition, the resulting image exhibits a high rub fastness and high image quality.

The upper limit of the nozzle face temperature when ink is applied onto the printing medium 10 in the ink application step, that is, the maximum temperature of the nozzle face during printing, may be 55° C. or less or 50° C. or less, for example, 45° C. or less or 40° C. or less. By controlling the nozzle face temperature in such a range when ink is applied, the impact of heat on the ink jet head 2 is reduced to prevent the ink jet head 2 and nozzles from being clogged. Also, the lower limit of the nozzle face temperature during ink jet printing may be higher than room temperature and may be 28° C. or more, for example, 30° C. or more or 32° C. or more. By controlling the nozzle face temperature in such a range during ink jet printing, the ink on the printing medium 10 can be rapidly dried and solidified, thus reducing bleeding to yield images exhibiting high rub fastness and high image quality. The nozzle face temperature when the ink is applied onto the printing medium 10 may be increased by the heat generated from the ink jet head 2 or any other devices of the printing apparatus or the heat of the above-described heating step.

The maximum period for one scan in the ink application step may be 0.8 s or more and may be, for example, from 0.8 s to 5 s, from 0.8 s to 4 s, or from 1.5 s to 2.5 s. The maximum period for one scan in such a range is suitable for printing on a printing medium with a width in the above-described range.

The “maximum period for one scan” mentioned herein is the period of time for which a point of the ink jet head opposing the printing medium moves when printing is performed across the printing medium from one end in the scanning direction to the other in one scan. When an image is printed, scanning may be performed a shorter period than the maximum period for one scan according to the image. The average scanning speed in the ink application step may be from 60 cm/s to 100 cm/s.

### 2. 3. Secondary Heating

The ink jet printing method disclosed herein may optionally include a secondary heating step (may be referred to as post-heating step) of heating the printing medium 10 having the applied ink composition on the surface thereof with the secondary heater 5 shown in FIG. 1 after the ink application step. Thus, the resin or the like in the ink composition on the printing medium 10 is melted to form an ink coating film and solidified to be firmly fixed to the printing medium 10, thus forming a high-quality image having a high fastness in a short time.

The upper limit of the surface temperature of the printing medium 10 heated by the secondary heater 5 may be 120° C. or less, for example, 110° C. or less or 100° C. or less. Also, the lower limit of the surface temperature of the printing medium 10 at this time may be 60° C. or more, for example, 70° C. or more or 80° C. or more. By controlling the surface temperature in such a range, high-quality images having a high rub fastness can be formed in a short time while clogging is suppressed.

After the secondary heating step, the ink composition on the printing medium 10 may be cooled with the cooling fan 6 shown in FIG. 1.

### 2. 4. Other Steps

The printing method disclosed herein may include a cleaning step of discharging the ink composition and the treatment liquid with a mechanism other than a pressure generator configured to eject ink for printing, that is, other than an ink ejection mechanism included in the ink jet head 2.

The ink ejection mechanism including in the ink jet head 2 may be a piezoelectric element or a heater element that is operable to apply a pressure to the ink and is disposed in a pressure generating chamber (not shown). The cleaning step may be performed by applying an external pressure to the ink jet head 2 to discharge the ink composition and the treatment liquid from the nozzle. This cleaning step reduces the risk of the resin melting and adhering to the inner wall of the ink jet head 2, thus helping stable ejection.

The mechanism operable for cleaning may be a mechanism configured to apply a negative pressure, a mechanism configured to apply a positive pressure upstream of the ink jet head, or any other mechanism capable of applying a pressure. The discharge of the ink and the treatment liquid is not the discharge by the function of the ink jet head itself, that is, by flushing. Hence, the discharge is not the operation performed by using a function to eject ink from the ink jet head.

As described above, in the ink jet printing method disclosed herein, which is a serial ink jet printing method using an ink composition and a treatment liquid, the treatment liquid nozzles through which the treatment liquid is ejected and ink nozzles through which the ink composition is ejected are arranged such that the arrangement of the treatment liquid nozzles and the arrangement of the ink nozzles include respective coincident portions that are coincident in position in the sub-scanning direction with each other and that account for 60% or more of the length in the subs-canning direction of the respective arrangements, and the treatment liquid is applied onto a region of the printing medium in a proportion of from 20% by mass to 50% by mass relative to the ink composition applied onto the region of the printing medium. When printing is performed on a poorly absorbent or non-absorbent printing medium under such conditions, image quality of images printed at a high speed can be increased.

### 3. Examples

The subject matter of the present disclosure will be further described in detail with reference to Examples and Comparative Examples, but it is not limited to the Examples.

### 3. 1. Preparation of Inks and Treatment Liquid

Constituents for each of inks and treatment liquids were mixed with the proportions shown in Table 1 or Table 2 and stirred in a bead mill. The mixture was filtered through a membrane filter of 5 μm in pore size, and, thus, inks 1 to 6 and treatment liquids R1 to R3 were prepared. Each pigment was dispersed in water with 50% by mass of a styrene-acrylic dispersant resin, and the resulting pigment dispersion liquid was used for preparation of the inks. Each value in Tables 1 and 2 represents the content of the corresponding constituent on a percent-by-mass basis, and ion exchanged water was added so that the total of the composition came to 100% by mass. The values for the pigments and the resins shown in Table 1 are represented in terms of solids content.

TABLE 1

| Ink name | | Ink 1 | Ink 2 | Ink 3 | Ink 4 | Ink 5 | Ink 6 |
|---|---|---|---|---|---|---|---|
| Ink color | | Black | Cyan | Magenta | Yellow | Light | Light |
| | | | | | | cyan | magenta |
| Organic | Propylene glycol | 5.00 | 5.00 | 5.00 | 5.00 | 5.00 | 5.00 |
| solvent | Dipropylene glycol | 7.00 | 7.00 | 7.00 | 7.00 | 7.00 | 7.00 |
| | dimethyl ether | | | | | | |
| | 2-Pyrrolidone | 13.00 | 13.00 | 13.00 | 13.00 | 13.00 | 13.00 |
| Pigment | Black pigment | 3.00 | | | | | |
| dispersion | Cyan pigment | | 3.00 | | | 0.75 | |
| liquid | Magenta pigment | | | 3.00 | | | 0.75 |
| | Yellow pigment | | | | 3.00 | | |
| Resin | Styrene-acrylic resin | 5.00 | 5.00 | 5.00 | 5.00 | 5.00 | 5.00 |
| | emulsion | | | | | | |
| | Wax emulsion | 2.00 | 2.00 | 2.00 | 2.00 | 2.00 | 2.00 |
| Antifoaming | DF110D | 0.10 | 0.10 | 0.10 | 0.10 | 0.10 | 0.10 |
| agent | | | | | | | |
| Surfactant | SILFACE SAG503A | 1.00 | 1.00 | 1.00 | 1.00 | 1.00 | 1.00 |

| | | | | | | |
|---|---|---|---|---|---|---|
| Pure water | Balance | Balance | Balance | Balance | Balance | Balance |
| Total | 100.00 | 100.00 | 100.00 | 100.00 | 100.00 | 100.00 |

TABLE 2

| Treatment liquid name | | R1 | R2 | R3 |
|---|---|---|---|---|
| Organic solvent | Dipropylene glycol | 15.0 | 15.0 | 15.0 |
| | dimethyl ether | | | |
| | 2-Pyrrolidone | 10.0 | 10.0 | 10.0 |
| Flocculant | MgSO₄•7H₂O | 5.0 | | |
| | Catiomaster PD-7 | | 5.0 | |
| | Succinic acid | | | 5.0 |
| Antifoaming agent | DF110D | 0.1 | 0.1 | 0.1 |
| Surfactant | SILFACE SAG503A | 1.0 | 1.0 | 1.0 |

| | | | |
|---|---|---|---|
| Pure water | Balance | Balance | Balance |
| Total | 100.0 | 100.0 | 100.0 |

The constituents shown in Tables 1 and 2 are as follows: Pigment
Black pigment: Carbon black
Cyan pigment: C.I. Pigment Blue 15:3
Magenta pigment: C.I. Pigment Red 122
Yellow pigment: C.I. Pigment Yellow 150 Resin
Styrene-acrylic resin emulsion: JONCRYL 62J, produced by BASF
Wax emulsion: AQUACER 539, modified paraffin for aqueous system, produced by BYK Antifoaming Agent
DF110D: SURFYNOL DF110D, acetylenediol-based surfactant, produced by Nissin Chemical Industry

### Surfactant

SILFACE SAG503A: siloxane-based surfactant produced by Nissin-chemical Industry Flocculant
Catiomaster PD-7: amine-epichlorohydrin condensation polymer, produced by Yokkaichi Chemical

### 3. 2. Printing Method

Printing was performed by using the inks shown in Table 1 and the treatment liquids shown in Table 2. An ink jet printer SC-S80650 (manufactured by Seiko Epson) was modified so that the temperature of the heater of the platen could be adjusted. The ink jet printer had a head having nozzles aligned in seven lines. Head Arrangement 1 shown in Tables 3 and 4 is a side-by-side head arrangement as shown in FIG. 3 but in which ink nozzles are aligned in six lines. Head Arrangement 2 is an arrangement as shown in FIG. 4 in which the line (group) of treatment liquid nozzles is located 30% upstream from the six lines of ink nozzles. The lines of the nozzles in Head Arrangements 1 and 2 have the same length in the sub-scanning direction.

One of the seven lines of the nozzles was used for the treatment liquid, and the other six lines were used for color inks. The nozzle density of the nozzles was 360 dpi. The resolution of the print pattern was set at 1440 dpi×1440 dpi at the maximum for each of the treatment liquid and inks, and the print pattern was formed by thinning or adding dots for the pixels so that the dots of each ink could be as uniformly arranged as possible. The print pattern measured 5 cm by 5 cm. The treatment liquid was applied in a proportion (percentage) shown in Tables 3 and 4. The inks were applied at a rate of 15 mg/inch² in total.

Printing was performed by alternately transferring the carriage equipped with the head to scan the printing medium set in the printer and transporting the printing medium (sub-scanning). The distance for one sub-scan was a one-eighth of the length of the line of the ink ejection nozzles through which ink was ejected, and the inks were applied in 8 passes. The nozzle face temperature when the treatment liquid and the inks were applied was set to the value shown in Tables 3 and 4 by controlling the platen heater. After applying the inks and the treatment liquid, the printing medium was secondarily heated at a surface temperature of 80° C. for about 1 minute with an after-heater disposed downstream from the platen. After completion of printing, the printed portion of the printing medium was allowed to stand at room temperature for one day and then subjected to the following examinations.

Ink Set 1 in Tables 3 and 4 consisted of Inks 1 to 6 shown in Table 1. Ink Set 2 consisted of inks prepared by reducing the solvent shown in Table 1, propylene glycol, dipropylene glycol dimethyl ether, and 2-pyrrolidone, by 1% each and adding 3% of glycerin instead.

Table 3 shows the results of printing in the first printing mode in which the coincident portion of the line of the treatment liquid nozzles accounts for 60% or more of the length in the sub-scanning direction of the line of the treatment liquid nozzles. Table 4 shows the results of printing in the second printing mode in which the coincident portion of the line of the treatment liquid nozzles accounts for 50% or less.

Each Print was performed with the usage of the treatment liquid nozzles shown in Tables 3 and 4. When the usage was less than 100%, some treatment liquid nozzles selected in the order of the sub-scanning direction from the most upstream nozzle were used as treatment liquid ejection nozzles. Also, the usage of the ink nozzles was set as shown in Tables 3 and 4, and when the usage was less than 100%, some ink nozzles selected in the order opposite to the sub-scanning direction from the most downstream nozzle were used as ink ejection nozzles. The usage of the ink nozzles was the same among the six groups (lines) of the ink nozzles.

The percentage (coincidence ratio) of the coincident nozzles of the treatment liquid ejection nozzles and the percentage (coincidence ratio) of the coincident nozzles of the ink ejection nozzles were set as shown in the Tables.

In Print D15 shown in Table 3, only the upper half of the treatment liquid nozzles were used for ejection; hence, the coincidence ratio of the treatment liquid ejection nozzles coincident with the ink ejection nozzles (coincident treatment liquid ejection nozzle percentage) was 100%, while the coincidence ratio of the ink ejection nozzles coincident with the treatment liquid ejection nozzle (coincident ink ejection nozzle percentage) was 50%. The coincident portions in Arrangement 2 were in the region indicated by Y in FIG. 4. In Print D14 shown in Table 3, accordingly, the coincident portion of the line of the treatment liquid ejection nozzles and the coincidence portion of each line of the ink ejection nozzles account for 70% of the respective lines.

The usage of the treatment liquid nozzles and the ink nozzles are shown in the Tables as described above.

In Print D1 shown in Table 3, thus, the usage of the ink nozzles was not 100%, and the coincidence ratio of the treatment liquid ejection nozzles was not 100% accordingly.

Three types of printing medium were prepared as follows: Printing Media
M1: IJ180-10, polyvinyl chloride film manufactured by 3M, non-absorbent printing medium
M2: OK Prince High Quality Paper (plain paper) manufactured by Oji Paper, absorbent printing medium
M3: OK Top Coat+, coated paper manufactured by Oji Paper, poorly absorbent printing medium

In Tables 3 and 4, the printing speed is represented in terms of percentage relative to the printing speed of the head having Arrangement 1 as shown in FIG. 3 with usages of treatment liquid nozzles and ink nozzles of 100% each, for example, relative to the printing speed in Print D3. “Head mass/arrangement 1” represents the percentage of the mass of the head to the mass of the head having Arrangement 1.

TABLE 3

| | Print D1 | Print D2 | Print D3 | Print D4 | Print D5 | Print D6 | Print D7 | Print D8 | Print D9 | Print D10 |
|---|---|---|---|---|---|---|---|---|---|---|
| Printing | M1 | M1 | M1 | M1 | M1 | M1 | M1 | M1 | M1 | M1 |
| medium | | | | | | | | | | |
| Medium | Non- | Non- | Non- | Non- | Non- | Non- | Non- | Non- | Non- | Non- |
| type | absorbent | absorbent | absorbent | absorbent | absorbent | absorbent | absorbent | absorbent | absorbent | absorbent |
| Head | Arrange- | Arrange- | Arrange- | Arrange- | Arrange- | Arrange- | Arrange- | Arrange- | Arrange- | Arrange- |
| arrangement | ment 1 | ment 1 | ment 1 | ment 1 | ment 1 | ment 1 | ment 1 | ment 1 | ment 1 | ment 1 |
| Coincident | 90% | 100% | 100% | 100% | 100% | 100% | 100% | 100% | 100% | 100% |
| treatment | | | | | | | | | | |
| liquid ejection | | | | | | | | | | |
| nozzle | | | | | | | | | | |
| percentage | | | | | | | | | | |
| Coincident ink | 100% | 100% | 100% | 100% | 100% | 100% | 100% | 100% | 100% | 100% |
| ejection | | | | | | | | | | |
| nozzle | | | | | | | | | | |
| percentage | | | | | | | | | | |
| Ink nozzle | 90% | 100.0% | 100.0% | 100.0% | 100.0% | 100.0% | 100.0% | 100.0% | 100.0% | 100.0% |
| usage | | | | | | | | | | |
| Treatment | 100.0% | 100.0% | 100.0% | 100.0% | 100.0% | 100.0% | 100.0% | 100.0% | 100.0% | 100.0% |
| liquid nozzle | | | | | | | | | | |
| usage | | | | | | | | | | |
| Ink set | Set 1 | Set 1 | Set 1 | Set 1 | Set 1 | Set 2 | Set 1 | Set 1 | Set 1 | Set 1 |
| Treatment | R1 | R1 | R1 | R1 | R1 | R1 | R2 | R3 | R1 | R1 |
| liquid | | | | | | | | | | |
| Percentage of | 15% | 15% | 20% | 25% | 40% | 40% | 40% | 40% | 60% | 40% |
| treatment | | | | | | | | | | |
| liquid to ink | | | | | | | | | | |
| Nozzle face | 35 | 35 | 35 | 35 | 35 | 35 | 35 | 35 | 35 | 30 |
| temperature | | | | | | | | | | |
| (° C.) | | | | | | | | | | |
| Image quality | D | D | C | B | B | C | C | C | B | C |
| (Bleeding) | | | | | | | | | | |
| Image quality | A | A | A | A | B | A | A | B | C | C |
| (Granularity) | | | | | | | | | | |
| Band-like | A | A | A | A | B | C | A | B | C | A |
| unevenness | | | | | | | | | | |
| Printing speed | 90% | 100% | 100% | 100% | 100% | 100% | 100% | 100% | 100% | 100% |
| Head mass/ | 100% | 100% | 100% | 100% | 100% | 100% | 100% | 100% | 100% | 100% |
| arrangement 1 | | | | | | | | | | |
| Ejection | A | A | A | B | B | A | A | A | C | A |
| stability (Ink) | | | | | | | | | | |

| | Print D11 | Print D12 | Print D13 | Print D14 | Print D15 | Print D16 | Print D17 | Print D18 |
|---|---|---|---|---|---|---|---|---|
| Printing | M1 | M3 | M3 | M1 | M1 | M2 | M2 | M2 |
| medium | | | | | | | | |
| Medium | Non- | Poorly | Poorly | Non- | Non- | Absorbent | Absorbent | Absorbent |
| type | absorbent | absorbent | absorbent | absorbent | absorbent | | | |
| Head | Arrange- | Arrange- | Arrange- | Arrange- | Arrange- | Arrange- | Arrange- | Arrange- |
| arrangement | ment 1 | ment 1 | ment 1 | ment 1 | ment 1 | ment 1 | ment 1 | ment 1 |
| Coincident | 100% | 100% | 100% | 70% | 100% | 100% | 100% | 100% |
| treatment | | | | | | | | |
| liquid ejection | | | | | | | | |
| nozzle | | | | | | | | |
| percentage | | | | | | | | |
| Coincident ink | 100% | 100% | 100% | 70% | 50% | 100% | 100% | 100% |
| ejection | | | | | | | | |
| nozzle | | | | | | | | |
| percentage | | | | | | | | |
| Ink nozzle | 100.0% | 100.0% | 100.0% | 100.0% | 100.0% | 100.0% | 100.0% | 100.0% |
| usage | | | | | | | | |
| Treatment | 100.0% | 100.0% | 100.0% | 100.0% | 50% | 100.0% | 100.0% | 100.0% |
| liquid nozzle | | | | | | | | |
| usage | | | | | | | | |
| Ink set | Set 1 | Set 1 | Set 1 | Set 1 | Set 1 | Set 1 | Set 1 | Set 1 |
| Treatment | R1 | R1 | R1 | R1 | R1 | R1 | R1 | R1 |
| liquid | | | | | | | | |
| Percentage of | 40% | 15% | 25% | 25% | 25% | 15% | 25% | 60% |
| treatment | | | | | | | | |
| liquid to ink | | | | | | | | |
| Nozzle face | 40 | 35 | 35 | 35 | 35 | 35 | 35 | 35 |
| temperature | | | | | | | | |
| (° C.) | | | | | | | | |
| Image quality | A | D | A | B | A | B | B | B |
| (Bleeding) | | | | | | | | |
| Image quality | A | A | A | A | A | A | A | B |
| (Granularity) | | | | | | | | |
| Band-like | B | A | A | B | B | A | A | C |
| unevenness | | | | | | | | |
| Printing speed | 100% | 100% | 100% | 100% | 100% | 100% | 100% | 100% |
| Head mass/ | 100% | 100% | 100% | 150% | 100% | 100% | 100% | 100% |
| arrangement 1 | | | | | | | | |
| Ejection | C | A | B | B | C | A | B | C |
| stability (Ink) | | | | | | | | |

TABLE 4

| | Print | Print | Print | Print | Print | Print | Print | Print | Print | Print | Print |
|---|---|---|---|---|---|---|---|---|---|---|---|
| | S1 | S2 | S3 | S4 | S5 | S6 | S7 | S8 | S9 | S10 | S11 |
| Printing | M1 | M1 | M3 | M1 | M1 | M1 | M1 | M1 | M1 | M2 | M2 |
| medium | | | | | | | | | | | |
| Medium | Non- | Non- | Poorly | Non- | Non- | Non- | Non- | Non- | Non- | Non- | Non- |
| type | absorbent | absorbent | absorbent | absorbent | absorbent | absorbent | absorbent | absorbent | absorbent | absorbent | absorbent |
| Head | Arrange- | Arrange- | Arrange- | Arrange- | Arrange- | Arrange- | Arrange- | Arrange- | Arrange- | Arrange- | Arrange- |
| arrangement | ment 1 | ment 1 | ment 1 | ment 1 | ment 1 | ment 1 | ment 1 | ment 1 | ment 1 | ment 1 | ment 1 |
| Coincident | 0% | 0% | 0% | 0% | 10% | 30% | 50% | 50% | 0% | 0% | 0% |
| treatment | | | | | | | | | | | |
| liquid ejection | | | | | | | | | | | |
| nozzle percentage | | | | | | | | | | | |
| Coincident ink | 0% | 0% | 0% | 0% | 10% | 30% | 50% | 50% | 0% | 0% | 0% |
| ejection | | | | | | | | | | | |
| nozzle percentage | | | | | | | | | | | |
| Ink nozzle usage | 50.0% | 50.0% | 50.0% | 65.0% | 52.6% | 58.8% | 66.7% | 66.7% | 50.0% | 50.0% | 50.0% |
| Treatment liquid | 50.0% | 50.0% | 50.0% | 65.0% | 52.6% | 58.8% | 66.7% | 66.7% | 50.0% | 50.0% | 50.0% |
| nozzle usage | | | | | | | | | | | |
| Ink set | Set 1 | Set 1 | Set 1 | Set 1 | Set 1 | Set 1 | Set 1 | Set 1 | Set 1 | Set 1 | Set 1 |
| Treatment liquid | R1 | R1 | R1 | R1 | R1 | R1 | R1 | R1 | R1 | R1 | R1 |
| Percentage of | 5% | 15% | 15% | 15% | 15% | 15% | 15% | 25% | 25% | 15% | 25% |
| treatment | | | | | | | | | | | |
| liquid to ink | | | | | | | | | | | |
| Nozzle face | 35 | 35 | 35 | 35 | 35 | 35 | 35 | 35 | 35 | 35 | 35 |
| temperature | | | | | | | | | | | |
| (° C.) | | | | | | | | | | | |
| Image quality | B | A | A | A | A | A | A | A | A | A | A |
| (Bleeding) | | | | | | | | | | | |
| Image quality | A | A | A | A | A | A | A | A | A | A | A |
| (Granularity) | | | | | | | | | | | |
| Band-like | A | B | A | B | B | B | B | C | C | A | B |
| unevenness | | | | | | | | | | | |
| Printing speed | 50% | 50% | 50% | 65% | 52% | 59% | 67% | 67% | 50% | 50% | 50% |
| Head mass/ | 100% | 100% | 100% | 150% | 100% | 100% | 100% | 100% | 100% | 100% | 100% |
| arrangement 1 | | | | | | | | | | | |
| Ejection stability | A | A | A | A | A | A | A | B | A | A | A |
| (Ink) | | | | | | | | | | | |

### 3. 3. Evaluation

### 3. 3. 1. Ejection Stability Through Ink Nozzles

A pattern was continuously printed for 2 hours with the above-described ink jet printer filled with the treatment liquid and the inks. The pattern included shapes measuring 5 cm by 5 cm and arranged in a matrix manner at intervals of 1 cm, and such a pattern was printed in a printable region of the printing medium. After printing, the number of nozzles that failed in ejection was counted, and the results were rated according to the criteria below. The number of nozzles that failed in ejection was for the ink nozzles used for ejection for printing.

Criteria

A: There was no nozzle that failed in ejection.
B: 2% or less of the nozzles failed in ejection.
C: More than 2% to 4% or less of the nozzles failed in ejection.
D: More than 4% of the nozzles failed in ejection.
3. 3. 2. Image Quality in Terms of Unevenness Resulting from Bleeding

The pattern printed in 3. 3. 1. was visually observed and rated according to the criteria below. The results rated as C or higher were determined to be no problem.

### Criteria

A: There was not observed an unevenness in density resulting from an aggregation of dots in the printed pattern. In addition, there were no deep-color portions formed by ink aggregation at some edges of the shapes of the printed pattern.
B: There was not observed an unevenness in density resulting from an aggregation of dots in the printed pattern, but there were deep-color portions formed by ink aggregation at a few edges of the shapes of the printed pattern.
C: There was slightly observed an unevenness in density resulting from an aggregation of dots in the printed pattern.
D: There was clearly visible unevenness resulting from an aggregation of dots in the printed pattern.

### 3. 3. 3. Image Quality in Terms of Granularity

The pattern printed in 3. 3. 1. was visually observed and rated according to the criteria below.

### Criteria

A: There was not observed granularity nor an evenly colored phenomenon.
B: There were observed a slight granularity and an evenly colored phenomenon.
C: There were observed granularity and marked evenly colored phenomenon.

### 3. 3. 4. Band-Like Unevenness

A pattern measuring 50 cm by 50 cm was printed and visually observed from a distance of 50 cm. When an unevenness formed by ink densities varying in the sub-scanning direction extended in the scanning direction, such an unevenness was considered to be a band-like unevenness. The printed pattern was evaluated according to the criteria below. The results rated as B or higher were determined to be no problem.

### Criteria

A: There was no band-like unevenness.
B: There was a slight band-like unevenness.
C: There was a clearly visible band-like unevenness.

### 3. 4. Evaluation Results

The results of evaluation are shown in Tables 3 and 4.

Prints D1 to D18 in the first printing mode will first be described.

Prints D3 to D8, D10, D11, and D13 to D15, in which printing was performed on a poorly absorbent or non-absorbent printing medium with a coincidence ratio of the treatment liquid ejection nozzles of 60% or more and an application of 20% by mass to 50% by mass of treatment liquid, exhibited particularly high image quality in terms of anti-bleeding and were superior particularly in anti-band-like unevenness. In contrast, the image quality produced in Prints D1, D2, D9, and D12, in which the treatment liquid was applied in a proportion outside the above range, was inferior to the image quality in the foregoing Prints in terms of anti-bleeding or anti-band-like unevenness.

When the proportion of the treatment liquid was reduced to less than the proportions applied in Prints D1 to D5 and D9, ejection stability was improved, but anti-bleeding was degraded. On the other hand, when the proportion of the treatment liquid was increased, evaluation in terms of granularity or band-like unevenness was reduced, and when it was excessively high, ejection stability was degraded.

The results in Prints D1 and D2 show that an excessively low proportion of the treatment liquid resulted in degraded anti-bleeding but improved ejection stability. This tendency also applied to the Prints with low coincident nozzle percentages.

The results in Print D6 show that the use of an ink containing a solvent having a high boiling point improved ejection stability but reduced the evaluation in terms of bleeding or band-like unevenness.

The results in Prints D5, D7, and D8 show that the use of a treatment liquid containing a cation polymer as a flocculant slightly reduced the evaluation in terms of anti-bleeding but improved the evaluation in terms of granularity, band-like unevenness, and ejection stability. Also, the use of a treatment liquid containing an organic acid as a flocculant slightly reduced the evaluation in terms of anti-bleeding but improved the evaluation in terms of ejection stability.

The results in Prints D5, D10, and D11 show that when the temperature during printing was reduced, evaluations in terms of anti-band-like unevenness and ejection stability were improved, but evaluation in terms anti-bleeding and granularity was reduced. On the other hand, when the temperature during printing was increased, evaluations in terms of ejection stability was reduced, but evaluation in terms of anti-bleeding or granularity was improved.

The results in Prints D4 and D13 show that the use of a poorly absorbent or non-absorbent printing medium improved evaluation in terms of anti-bleeding. On the other hand, the results in Prints D2 and D12 show that an application of treatment liquid in a low proportion did not improve image quality in terms of anti-bleeding even though a coated paper or a similar printing medium was used.

The results in Prints D4 and D14 show that the use of Arrangement 2, in which the line of treatment liquid nozzles was shifted upstream, increased the size of the head to larger than the head having nozzles in Arrangement 1 and degraded evaluation in terms of band-like unevenness. On the other hand, the results in Prints D4 and D15 show that evaluation in terms of band-like unevenness and ejection stability in Print D15 using the upper half of treatment liquid nozzles were reduced, but the evaluation in terms of anti-band-like unevenness was improved.

Prints D16 to D18 were performed on an absorbent printing medium. In the Prints on the absorbent printing medium, image quality in terms of anti-bleeding was not inferior in spite of an application of treatment liquid in a low proportion. This suggests that the treatment liquid should be applied in a proportion in a specific range or higher than the specific range for printing on a poorly absorbent or non-absorbent printing medium. However, when the proportion of the treatment liquid was excessively high, evaluation in terms of band-like unevenness was reduced. Also, the lower the proportion of the treatment liquid, the higher the evaluation in terms of ejection stability.

Prints S1 to S11 in the second printing mode will now be described.

Prints S1 to S7 and S10, in which printing was performed on a poorly absorbent or non-absorbent printing medium with a coincidence ratio of the treatment liquid ejection nozzles of 50% or less and an application of the treatment liquid in a proportion below the specific range, exhibited particularly high image quality in terms of anti-bleeding and were superior particularly in anti-band-like unevenness. In contrast, Prints S8 and S9, in which the treatment liquid was applied in a proportion of 25%, were inferior to the foregoing Prints in terms of anti-band-like unevenness.

When the proportion of the treatment liquid was reduced to less than the proportions applied in Prints S1, S2, and S9, ejection stability was improved, but the evaluation in terms of anti-bleeding was reduced. However, when the proportion of the treatment liquid was excessive, the evaluation in terms of anti-band-like unevenness was reduced.

The results in Prints S8 and S9 show that when printing was performed under the conditions of a high treatment liquid proportion and a high coincidence ratio, the evaluation in terms of ejection stability was reduced.

Print S2, in which the treatment liquid was applied in a proportion of 15%, is considered to be inferior in image quality in terms of anti-bleeding if printing is performed in the first printing mode. However, Print S2 printed in the second printing mode exhibited a high image quality in terms of anti-bleeding. This suggests that printing in the first printing mode should be performed with an application of the treatment liquid in a proportion of 20% or more.

Print S8, in which the treatment liquid was applied in a proportion of 25%, is considered to be inferior in anti-band-like unevenness if printing is performed in the first printing mode. However, Print S8 printed in the second printing mode exhibited a high anti-band-like unevenness. This suggests that printing in the first printing mode should be performed with an application of the treatment liquid in a proportion lower than in the first printing mode.

The results in Prints S2 and S3 show that the use of a poorly absorbent coated paper improved the evaluation in terms of anti-band-like unevenness.

The results in Prints S2 and S4 show that the use of Arrangement 2, in which the line (group) of the treatment liquid nozzles was shifted upstream, produced the same evaluation as the side-by-side arrangement in terms of image quality and ejection stability but resulted in a low printing speed and a larger head.

The results in Prints S2 and S5 to S7 show that arrangements with a high coincidence ratio reduced the evaluation in terms of anti-band-like unevenness but increased printing speed.

Print S11 was performed on an absorbent printing medium. The comparison between Prints S9 and S11 shows that printing on an absorbent medium resulted in a relatively high anti-band-like unevenness even though the treatment liquid is applied in a proportion of 25%. This suggests that the treatment liquid should be applied in a proportion in a specific range or lower than the specific range for printing on a poorly absorbent or non-absorbent printing medium. Also, printing on an absorbent printing medium can be satisfactorily performed.

### 3. 5. Evaluation of Apparatuses

Apparatuses 1 to 5 having a combination of the first printing mode in Table 3 and the second printing mode in Table 4 will now be described with reference to Table 5. The test for the Apparatuses was performed in the first printing mode and the second printing mode by using the same printing apparatus and controlling the control unit of the same printing apparatus.

TABLE 5

| | Apparatus 1 | | Apparatus 2 | | Apparatus 3 | | Apparatus 4 | | Apparatus 5 | |
|---|---|---|---|---|---|---|---|---|---|---|
| | 1st | 2nd | 1st | 2nd | 1st | 2nd | 1st | 2nd | 1st | 2nd |
| | Printing | Printing | Printing | Printing | Printing | Printing | Printing | Printing | Printing | Printing |
| | mode | mode | mode | mode | mode | mode | mode | mode | mode | mode |
| Print | Print D4 | Print S2 | Print D13 | Print S3 | Print D4 | Print S10 | Print D4 | Print S8 | Print D2 | Print S2 |
| Printing medium | M1 | M1 | M3 | M3 | M1 | M2 | M1 | M1 | M1 | M1 |
| Medium type | Non- | Non- | Poorly | Poorly | Non- | Absorbent | Non- | Non- | Non- | Non- |
| | absorbent | absorbent | absorbent | absorbent | absorbent | | absorbent | absorbent | absorbent | absorbent |
| Head | Arrange- | Arrange- | Arrange- | Arrange- | Arrange- | Arrange- | Arrange- | Arrange- | Arrange- | Arrange- |
| arrangement | ment 1 | ment 1 | ment 1 | ment 1 | ment 1 | ment 1 | ment 1 | ment 1 | ment 1 | ment 1 |
| Coincident | 100% | 0% | 100% | 0% | 100% | 0% | 100% | 50% | 100% | 0% |
| treatment | | | | | | | | | | |
| liquid ejection | | | | | | | | | | |
| nozzle percentage | | | | | | | | | | |
| Coincident ink | 100% | 0% | 100% | 0% | 100% | 0% | 100% | 50% | 100% | 0% |
| ejection nozzle | | | | | | | | | | |
| percentage | | | | | | | | | | |
| Ink nozzle usage | 100.0% | 50.0% | 100.0% | 50.0% | 100.0% | 50.0% | 100.0% | 66.7% | 100.0% | 50.0% |
| Treatment liquid | 100.0% | 50.0% | 100.0% | 50.0% | 100.0% | 50.0% | 100.0% | 66.7% | 100.0% | 50.0% |
| nozzle usage | | | | | | | | | | |
| Ink set | Set 1 | Set 1 | Set 1 | Set 1 | Set 1 | Set 1 | Set 1 | Set 1 | Set 1 | Set 1 |
| Treatment liquid | R1 | R1 | R1 | R1 | R1 | R1 | R1 | R1 | R1 | R1 |
| Percentage of | 25% | 15% | 25% | 15% | 25% | 15% | 25% | 25% | 15% | 15% |
| treatment | | | | | | | | | | |
| liquid to ink | | | | | | | | | | |
| Nozzle face | 35 | 35 | 35 | 35 | 35 | 35 | 35 | 35 | 35 | 35 |
| temperature | | | | | | | | | | |
| (° C.) | | | | | | | | | | |
| Image quality | B | A | A | A | B | A | B | A | D | A |
| (Bleeding) | | | | | | | | | | |
| Image quality | A | A | A | A | A | A | A | A | A | A |
| (Granularity) | | | | | | | | | | |
| Band-like | A | B | A | A | A | A | A | C | A | B |
| unevenness | | | | | | | | | | |
| Printing speed | 100% | 50% | 100% | 50% | 100% | 50% | 100% | 67% | 100% | 50% |
| Head mass/ | 100% | 100% | 100% | 100% | 100% | 100% | 100% | 100% | 100% | 100% |
| arrangement 1 | | | | | | | | | | |
| Ejection stability | B | A | B | A | B | A | B | B | A | A |
| (Ink) | | | | | | | | | | |

Apparatuses 1 to 3 (of Apparatuses 1 to 5) whose first printing mode was performed with an application of the treatment liquid in a higher proportion than in the second printing mode relative to the ink composition each produced a high image quality in terms of antibleeding and anti-band-like unevenness. These were also produced such high image quality even on printing media that vary in absorbency, including an absorbent printing medium.

In contrast, Apparatuses 4 and 5 whose first printing mode was performed with an application of the treatment liquid in a proportion not higher than in the second printing mode relative to the ink composition produced insufficient image quality in terms of antibleeding or anti-band-like unevenness.

The Apparatuses may have a combination of one of the Prints in the first printing mode and one of the Prints in the second printing mode without being limited to the combinations described above.

Thus, the head for serial printing can be downsized by arranging the nozzles so that the arrangement (group) of treatment liquid nozzles and the arrangement (group) of ink nozzles are at least partially coincident in position in the sub-scanning direction. Also, such nozzle arrangement enables the carriage to have a simple structure that can be used in existing apparatuses. Even though the head is downsized, image quality can be improved while printing speed is increased by controlling the proportion of the treatment liquid to be applied to the ink composition to be applied in a specific range. In addition, by combining two printing modes performed with difference coincidence ratio of the treatment liquid nozzles with the ink nozzles, image quality can be improved on printing media that vary in absorbency while printing speed is increased.

The implementation of the subject matter disclosed herein is not limited to the above-described embodiments, and various modifications may be made. For example, the subject matter disclosed herein may be implemented in substantially the same manner as any of the disclosed embodiments (for example, in terms of function, method, and results, or in terms of purpose and effect). Some elements used in the disclosed embodiments but not essential may be replaced. Implementations producing the same effect as produced in the disclosed embodiments or achieving the same object as in the disclosed embodiments are also within the scope of the subject matter of the present disclosure. A combination of any of the disclosed embodiments with a known art is also within the scope of the subject matter of the present disclosure.

What is claimed is:

1. An ink jet printing method that performs printing by applying an ink composition and a treatment liquid acting to flocculate one or more constituents of the ink composition onto a poorly absorbent or non-absorbent printing medium, the method comprising:
a printing step of performing scanning a plurality of times, the scanning being an operation performed by ejecting the treatment liquid and the ink composition from an ink jet head that is being transferred in a scanning direction to apply the treatment liquid and the ink composition onto the printing medium; and
a transport step of transporting the printing medium in a sub-scanning direction intersecting the scanning direction,
wherein
the ink jet head has an arrangement of treatment liquid ejection nozzles that includes a coincident portion, and an arrangement of ink ejection nozzles that includes a coincident portion, and the coincident portion of the arrangement of the treatment liquid ejection nozzles and the coincident portion of the arrangement of the ink ejection nozzles are coincident in position in the sub-scanning direction with each other, and
wherein
in the printing step, the coincident portion of the arrangement of the treatment liquid ejection nozzles accounts for 60% or more of the length in the sub-scanning direction of the arrangement of the treatment liquid ejection nozzles, and the treatment liquid is applied onto a region of the printing medium in a proportion of from 20% by mass to 50% by mass relative to the ink composition applied onto the region.

2. The ink jet printing method according to claim 1, wherein the proportion of the treatment liquid applied onto the region of the printing medium relative to the ink composition applied onto the region is from 20% by mass to 40% by mass.

3. The ink jet printing method according to claim 1, wherein
the ink jet head has an arrangement of treatment liquid nozzles including the arrangement of the treatment liquid ejection nozzles, and an arrangement of ink nozzles including the arrangement of the ink ejection nozzles, and
the arrangement of the ink nozzles has a usage of 60% or more, the usage being represented by the following equation:
usage (%)=(length in the sub-scanning direction of the arrangement of the ink ejection nozzles)/(length in the sub-scanning direction of the arrangement of the ink nozzles)×100.

4. The ink jet printing method according to claim 1, wherein
in the printing step, the coincident portion of the arrangement of the treatment liquid ejection nozzles accounts for 90% or more of the length in the sub-scanning direction of the arrangement of the treatment liquid ejection nozzles.

5. The ink jet printing method according to claim 1, wherein
in the printing step, the coincident portion of the arrangement of the ink ejection nozzles accounts for 70% or less of the length in the sub-scanning direction of the arrangement of the ink ejection nozzles.

6. The ink jet printing method according to claim 1, wherein
the ink composition contains 1% by mass or less of a polyol organic solvent having a normal boiling point of more than 280° C. relative to the total mass of the ink composition.

7. The ink jet printing method according to claim 1, wherein
the treatment liquid contains a flocculant selected from the group consisting of multivalent metal salts, cationic resins, and organic acids.

8. The ink jet printing method according to claim 1, wherein
the ink jet head has a nozzle face at which the nozzles are arranged, and the nozzle face at the ink nozzles has a surface temperature of from 30° C. to 50° C. when the ink composition is applied onto the printing medium in the printing step.

9. The ink jet printing method according to claim 3, wherein
in the printing step, the arrangement of the ink nozzles is coincident in position with the arrangement of the treatment liquid nozzles in a percentage of 90% or more relative to the length in the sub-scanning direction of the arrangement of the ink nozzles.

10. An ink jet printing apparatus operable to apply an ink composition and a treatment liquid acting to flocculate one or more constituents of the ink composition onto a printing medium for printing, the ink jet printing apparatus comprising:
an ink jet head having an arrangement of ink nozzles and an arrangement of treatment liquid nozzles;
a transfer device configured to transfer the ink jet head in a scanning direction;
a transport device configured to transport the printing medium in a sub-scanning direction intersecting the scanning direction, and
a control unit configured to control ejection of the ink composition and the treatment liquid from the ink jet head and to select treatment liquid ejection nozzles from the treatment liquid nozzles and ink ejection nozzles from the ink nozzles for each of a first printing mode and a second printing mode, the treatment liquid ejection nozzles being nozzles through which the treatment liquid is ejected during printing and forming an arrangement thereof, the ink ejection nozzles being nozzles through which the ink composition is ejected during printing and forming an arrangement thereof,
wherein
the arrangement of the treatment liquid ejection nozzles includes a coincident portion, the arrangement of the ink ejection nozzles include a coincident portion, and the coincident portion of the arrangement of the treatment liquid ejection nozzles and the coincident portion of the arrangement of the ink ejection nozzles are coincident in position in the sub-scanning direction with each other,
wherein
the coincident portion of the arrangement of the treatment liquid ejection nozzles in the first printing mode accounts for 60% or more of the length in the sub-scanning direction of the arrangement of the treatment liquid ejection nozzles, and the coincident portion of the arrangement of the treatment liquid ejection nozzles in the second printing mode accounts for 50% or less of the length in the sub-scanning direction of the arrangement of the treatment liquid ejection nozzles, and
wherein
the treatment liquid is applied onto a region of the printing medium in a proportion relative to the ink composition applied onto the region of the printing medium, and the proportion of the treatment liquid applied in the first printing mode is higher than the proportion of the treatment liquid applied in the second printing mode.

11. The ink jet printing apparatus according to claim 10, wherein
the proportion of the treatment liquid applied in the first printing mode is 1.5 times or more the proportion of the treatment liquid applied in the second printing mode.

12. The ink jet printing apparatus according to claim 10, wherein
the coincident portion of the arrangement of the treatment liquid ejection nozzles in the second printing mode accounts for 30% or less of the length in the sub-scanning direction of the arrangement of the treatment liquid ejection nozzles.

13. The ink jet printing apparatus according to claim 10, wherein
in the second printing mode, the proportion of the treatment liquid applied onto a region is from 5% by mass to 20% by mass relative to the ink composition applied onto the region.

14. The ink jet printing apparatus according to claim 10, wherein
the proportion of the treatment liquid applied in the first printing mode and the proportion of the treatment liquid applied in the second printing mode are proportions of the treatment liquid when applied onto the same type of printing medium.

15. The ink jet printing apparatus according to claim 10, wherein
printing in the first printing mode is performed on a poorly absorbent or non-absorbent printing medium.

16. The ink jet printing apparatus according to claim 10, wherein
in the second printing mode, the coincident portion of the arrangement of the ink ejection nozzles accounts for 50% or less of the length in the sub-scanning direction of the arrangement of the ink ejection nozzles.

17. The ink jet printing apparatus according to claim 10, wherein
the arrangement of the ink nozzles in the second printing mode has a usage of 60% or more, the usage being represented by the following equation:
usage (%)=(length in the sub-scanning direction of the arrangement of the ink ejection nozzles)/(length in the sub-scanning direction of the arrangement of the ink nozzles)×100.
